(19) United States
(12) Patent Application Publication
(10) Pub. No.: US 2013/0254117 A1
(43) Pub. Date: Sep. 26, 2013

(54) SECURED TRANSACTION SYSTEM AND METHOD

(71) Applicants: Clay W. von Mueller, San Diego, CA (US); Paul E. Catinella, San Diego, CA (US)

(72) Inventors: Clay W. von Mueller, San Diego, CA (US); Paul E. Catinella, San Diego, CA (US)

(21) Appl. No.: 13/725,441

(22) Filed: Dec. 21, 2012

Related U.S. Application Data
(60) Provisional application No. 61/581,733, filed on Dec. 30, 2011.

(51) Int. Cl. G06Q 20/38

(52) U.S. Cl. CPC G06Q 20/3829
USPC 705/71

(57) ABSTRACT

Systems and methods for performing financial transactions are provided. In one embodiment, the invention provides for method for bank card transactions, including: reading the token information at the point of swipe for traditional and non-traditional POS platforms; performing a low-security task on the token information using a first microprocessor, wherein the non-security task includes one or more tasks from the group of encryption determination, encryption-decryption request, key management, token information delivery, or transactional data delivery; and performing a security-related task on the token information using a second microprocessor based on a request from the first microprocessor, wherein the security-related task includes one or more tasks from the group of token information authentication, token information decryption, or token information encryption. Formatting the encrypted information such that it is compatible with the format of the current POS system.

### TECHNICAL FIELD

The present invention relates to secure transactions, and more particularly, some embodiments related to a secured transaction system for securing transactions and access authorization over a network.

### DESCRIPTION OF THE RELATED ART

Token systems have been in use in modern civilization in various implementations to provide and control many forms of access. Access that can be and often times is controlled by tokens can include physical access to rooms, buildings, areas and so on; electronic, access to servers and data files; electronic account access; and so on. Another form of access controlled by tokens is the ability to conduct transactions such as, for example, credit, debit and other financial transactions. Credit cards, charge cards, debit cards, loyalty cards and other purchase-related tokens are used to provide the consumers with ready access to funds. Such transactions can enhance convenience of purchases, extend credit to customers, and so on.

As modern society has evolved, so have our tokens. Early tokens included physical objects such as coins, documents, and other physical objects. One example of a simple physical object token is the subway token made famous by the New York subway system. This simple token resembled a coin, and could be purchased at kiosks and was used to control access to the subway system. Another example of simple physical token for granting access was the early railway token developed, in the 19th century for the British railway system. This token was a physical object, such as a coin, that a locomotive engineer was required to have before entering a particular section of the railway. When the train reached the end of the section, the driver left the token at a drop point so it could be used by the next train going the other way. Because there was only one token for a given section of railway, the token system helped to ensure that only one train would be on that section of the track at a given time.

The railway token system minimized the likelihood of head on collisions, but this simple token also limited the ability for trains to follow one another along a given section. As such, the system evolved into a token and ticket system. In this system, if a train reached a checkpoint and the token was present, the driver was given a ticket to pass, leaving the token in place in case another train approached that section traveling in the same direction. Safeguards were implemented to ensure that tickets were correctly issued. As technology evolved, the physical token and ticket system evolved to include electronic signaling to control access to sections of the railway.

Other examples of tokens to grant access are charge cards, credit cards and debit cards. Some attribute the ‘invention’ of credit cards to Edward Bellamy, who described them in his 19th century novel Looking Backward. Early cards were reportedly used in the early 20th century United States by fuel companies and by Western Union. By mid-century, Diners Club produced a charge card for merchant purchases, which was followed shortly thereafter by American Express. These cards, now ubiquitous in our society, allow customers to make purchases and conduct transactions with relative ease. Early cards were embossed with a customer account number, which was manually transferred to a receipt via a carbon transfer process. Modern cards, or tokens, have evolved to use electronic mechanisms of storing data including, for example, magnetic stripes, REID tags, biometric, based tokens including fingerprints, iris scans, voice recognition and smart card and chip card technologies.

Other examples of tokens include government issued IDs such as driver's licenses and passports. Such tokens can also be used to control access in various forms. For example, a passport can be used to control access to countries and regions. Passports can also be used to access employment and licensing opportunities as a document to prove the holder's citizenship. A driver's license is another form of token, allowing access to driving privileges, and to establishments requiring proof of identity, residency or age. Still other examples of tokens can include bank drafts, stock certificates, currency and other token items relating to finance. Still further token examples can include tokens for physical access and security such as keys, card keys, RF or LC cards, RFID tokens, toll road transponders, and the like.

As these examples illustrate, the use of tokens for various forms of access has gained popularity in various business and industries and has evolved to embrace newly developed technologies. Tokens are not limited to these examples, but can take on various forms and use various instrumentalities and control, govern or arbitrate various forms of access in a variety of different ways. One downside of token access, however, is the opportunity to defraud the system. For example, stolen or counterfeited tokens are often used to gain unauthorized access. In fact, the Federal Trade Commission reports that credit and charge card fraud costs cardholders and issuers hundreds of millions of dollars each year.

Computer programs that are used to secure tokens to prevent fraud are themselves open to attack. To prevent rogue application programs, Trojan horse attacks or viruses from gaining access to the systems using for processing tokens, testing and certification must be completed on the operating system and all applications that can access sensitive information. Even a minor change to an application with no direct access to sensitive data can provide a path for compromising the system. An application that forces a buffer overflow condition has been known to grant complete access to all resources within a computer, including any sensitive data areas. In order to protect against security failure when any part of the security system is changed, all of the application and the operating system must be retested.

Current trends of using mobile platforms including mobile phones, tablets and PDAs and their corresponding operating systems as platforms for processing financial transactions has enabled millions of small merchants to process financial token based transactions. This trend has also supplied a platform for hackers that can be attacked anonymously from private locations rather that at a customer facing POS in a traditional brick and mortar store. Security policies and procedure to adequately handle this new system vulnerability are still lacking.

Due to the large scale loss of sensitive financial data the Payment Card Industry (PCI) was formed as a regulating body to introduce regulations to protect against the loss of sensitive financial data. Included in the new regulations is the use of data encryption and the protection of the associated encryption keys. PCI compliance specifications describe requirements for testing, and auditing financial transaction networks and devices. Among the requirements imposed by these standards is the periodic validation testing of financial processing networks along with conformance testing of hardware devices for token entry. While, these standards have reduced the loss of sensitive financial data, the subsequent manufacture and use of fraudulent financial tokens have limited their effectiveness because the testing is periodic rather than real time. One large financial institution lost sensitive data only one week after passing a data security validation test.

Data encryption has brought a system view to the payment card network. In the past the magstripe reader output clear text to the POS which in turn placed that information in a gateway compatible clear text message which could be reformatted at the gateway or processor to for Visa Net or any other backend system. The terminal manufacturer had little need to understand the payment backend network. Now with the addition of encryption the data keys must be maintained at both ends of each data hop so that the data can be decrypted reformatted and encrypted for the next hop. In addition each server where the data is in the clear must be certified routinely for the new security measures to prevent data and key loss. In some systems the data encrypted in the magstripe reader can be sent to the issuing bank before it is decrypted while in other systems it is decrypted in the POS. To successfully implement a secure data exchange between the cardholders swipe of his credit card at the POS and that data reaching the issuing bank for authorization requires that each POS transaction be understood on a system level.

The security issues brought to light with the addition of encryption to the magstripe reader have been widespread. It has been common for hospitality POS systems including restaurants to enter card data into non-secure PC based POS systems. These systems in turn have been a major focus of attack to attain valid transaction data to use in fraudulent transactions. Valid card data has regularly been found in used PC based POS terminal purchased form eBay by the author. Much of the stolen credit card magstripe data has come from restaurant POS system where malicious software inserted into the POS copies credit card information and delivers it via email or USB drive to the attacker.

In addition to the new requirements for hospitality, call centers routinely take customer data and enter it into call center POS terminals, which are based on non-secure PC platforms. For these systems in addition to the vulnerabilities of malicious software inserted into the POS the manual entry of cardholder data is susceptible to loss from data scanning bugs placed into the device or remote cameras viewing the device display.

Data encryption requires the use of significant computing power to address the needs of the algorithms employed. In a single magstripe read operation of a POS terminal, the effect of an encryption cycle for a single purchase is not significant. Yet for a gateway or processor which may receive thousands of transaction requests from multiple terminals each second the computing resources are formidable. One benchmark requires a decryption appliance to be able to perform one thousand decryptions per second.

Recently updated PCI standards including the use of encryption and the protection of associated encryption keys will help to reduce the loss of sensitive financial data when they become fully implemented. During this transition period multiple years will pass that only a portion of the sensitive financial data is adequately protected from the point of entry throughout the financial transaction networks and devices.

Encryption, key management and control functions required by the PCI 3.0 mandate that the magstripe readers in POS devices, that currently transmit unprotected data, to protect all financial data and the associated encryption keys with a high level of certainty. Currently only Pin Entry Devices are required to meet this level of security. The costs imposed by these new standards related to key management can be staggering.

### BRIEF SUMMARY OF EMBODIMENTS OF THE INVENTION

According to one or more embodiments of the invention, various features and functionality can be provided to enable or otherwise facilitate various forms of token transactions. Particularly, in accordance with one aspect of the invention, data security techniques such as, for example, token and pin data encryption and authentication can be implemented at the edge of the network.

Token and pin data encryption and authentication may be done by adding an intelligent security module at the edge of the payment network. Preferably, the intelligent security module is located at or near the point of sale and at the point of swipe for transaction card data entry. The security module may include, in one embodiment: a first application microprocessor configured to perform a non-security task on a token information, wherein the non-security task includes one or more tasks from the group including: decoding magstripe data, outputting status information to display devices, processing non-security related applications, processing communication channels such as USB and corn ports, providing keypad scanning functions, providing radio communication support, accepting and processing command requests, encryption determination, encryption-decryption request, key management, token information delivery, or transactional data delivery; and a second security microprocessor configured to perform security-related tasks based on a request from the first microprocessor, wherein the security-related tasks includes one or more tasks from the group of token information authentication, token information decryption, or token information encryption, random number generation, symmetric key encryption including VDES, TDES and AES, public key encryption and authentication, security related command decryption, decoding and application processing. Limiting access of the application processor to the security processor prevents rogue applications running on the application processor from creating adverse affects on the security processor though buffer over-run or other attacks because none of the security processor resources are directly connected to the application processor resources. In one embodiment, a single, well-defined mailbox is the only communication channel between the two processors. Only commands defined for the mailbox interface are executed providing a secure firewall between the two processors.

in one embodiment, the security microprocessor used to protect encryption keys and decrypt, reformat and re-encrypt transaction data is based on smart card technology and provides various attack defeating technologies not provided by the application processor including differential power analysis, chip security grids and automatic key deletion among others.

In one embodiment, the application processor and the security processor are permanently linked at manufacture during the first power-up cycle. Each processor generates random keys and passes them to the other using asymmetric or symmetric key methodologies. Once the new keys are transferred, the power-up keys are deleted and the power-up key process permanently disabled.

Initial secure key loading and reloading represents one of the most difficult aspects of encryption. In one embodiment, using a security processor based on smart card technology, the initial keys and certificates are loaded using the current secure infrastructure during the production of the security processor in the same manner as smart cards are loaded today. These are the same type of smart cards that are used to transfer keys and certificates between hardware security modules used to protect transactional data by financial institutions.

In one embodiment, man in the middle attacks are prevented during manufacture by having the application processor generate a random key and encrypt it with the security processors public key prior to sending it to the security processor. The security processor decrypts the received key uses the key to encrypt a randomly generated local key with the application processors generated and return it to the application processor. A man in the middle can mimic the application processor by encrypting is own key yet it will not be able to decrypt data encrypted by the application processor using, its key. Since the encrypted data from the security processor to be transferred from the application processor over a network to the financial institution is wrapped in the application processors key and must be unwrapped prior to transmission the man in the middle cannot send data through the application processor. Further since the security processor is loaded with keys at manufacture and prior to this wedding process with the application processor the man in the middle cannot impersonate the security processor to the application processor.

in many new transaction processing applications the traditional POS terminal has been replaced with alternative platform devices such as mobile phones and handheld computers. Unlike the traditional POS terminal which have security measures including secure operating systems, only applications that have been pre-tested for security vulnerabilities, anti-tamper devices built into the enclosure along with PCI certification testing, these new platforms are known to have vulnerabilities that may allow for the transaction data to be compromised. In one embodiment, the intelligent security module is located such that the transaction data is collected at the point of entry and secured prior to entering the point of sale device.

In one embodiment, in the case of mobile phones and tablets the data is collected and encrypted prior to being sent as audio input to the phone using the microphone jack, in addition the headphone output is used to supply data and power to the security module via audio tones.

In one embodiment, in the case of mobile phones and tablets the data is collected and encrypted in an accessory to the mobile device prior to being, sent via a platform provided communication connection. In one embodiment, the connection is via a wireless link and in another, the connection is via a hardware connection. In addition, the hardware connection is used to supply data and power to the security module and token reader.

In one embodiment, the financial token reader accessory is used to verify the user of the POS device by reading an identity token of the same physical nature as the financial token. In one case the financial token is a credit card containing the customers financial transaction information and the POS users token is a magstripe card with the same physical nature as the credit card encoded with the POS users identity information. In another embodiment the POS users token is authenticated when swiped using a magstripe authentication system such as Warble® and the results used to allow or deny the POS transactions. In yet another embodiment Warble® is also used to authenticate the credit card token.

In one embodiment, the financial token reader accessory includes a biometric token reader. The biometric token reader is being used to verify the POS operators biometric credentials to allow or deny POS operations. In one embodiment, the biometric token reader consists of a fingerprint reader in addition to a magstripe reader. The POS operator swipes his enrolled finger over the fingerprint reader verifying his identity and then the customer swipes their credit card.

In one embodiment, the financial token reader accessory is used in conjunction with a PC based POS system for the entry of swiped magstripe data and manual entered card data where the keyboard and display is configured to lower the risk of a malicious device from reading non-encrypted data. In one embodiment the tradition LCD display is replaced with LEDs on the keys and to show key entry without showing the digits entered.

In one embodiment, the token to be secured is biometric information captured at the time of the transaction, combined with local and remote device and transactional data and issuer and account identity information. Biometric information can be, by way of example, but is not limited to, a fingerprint, a fingerprint template, an eye scan, or any other biometric information to determine an individual person's identity. Local device information can include, by way of example but not limited to, the serial number of a POS device, geographic location at time of sale, a phone number or MAC address of a mobile device, or a previously exchanged secret or key stored in the POS device or the security processor. Transactional data can include, but is not limited to, any information about the entity providing goods or services, a date, a description and price of the services or goods, geographic data indicating the location of the service or sale of goods. Because this embodiment securely ties together the issuer, the purchaser, and the seller for a given goods or services transaction, it facilitates bypassing the current payment card industry infrastructure, especially when the security module is preloaded with issuer keys or certificates.

In one embodiment, where the platform provides for attachment authentication, such as supported by Apple iAP devices, the authentication chip is used to replace or enhance the token input device security processor.

In the case of mobile phone magnetic stripe reader accessories that receive power form the headphone jack power management is a crucial aspect of the system design. In general, the headphone output from a mobile phone is in the order of ±500 Mv. In one embodiment a unique circuit has been developed that uses the dual stereo channels to double the output voltage. A variety of unique methods to use this technique are presented. In each case the forward diode voltage (Vf) drop of the rectifier diodes must be taken into account. The Vf presents a series voltage drop to the signal to be rectified. The Vf reduces the amount of voltage available to power the circuit. A full wave bridge rectifier lowers the output by two time the Vf. Diodes optimized for low voltage drop 50 mV to 350 mV depending on the current level flowing through them. On method uses a full wave bridge rectifier and id the least efficient. The full wave rectifier takes an AC input signal around and outputs pulsed DC signal referenced to ground. The diodes also prevent current flow back through the diodes when the pulsed voltage is lower that the output voltage across the filter capacitor. Another method uses four FET transistors to steer the input AC voltage so that the voltage is referenced to ground and a diode to prevent the reverse current flow. This lowers the Vf to that of one diode drop. As the current flow through a diode increases so does the voltage drop. In another method multiple diodes are placed in parallel to lower the Vf by spreading the current among multiple diodes. As any individual diode current goes up in relation to the others its VF will increase lowering its current relative to the others. By spreading the current over three diodes of an audio jack transaction card reader the Vf can be reduced significantly. In another method, a transformer can be used with the previous methods to increase the voltage present to power the device and the expense of lowering the current available.

In addition, in the case of mobile phone magnetic stripe readers that receive power by driving the two output channels 180 degrees out of phase the ground reference of the powering device must be taken into consideration. The mobile phone ground reference must be maintained for AC signals. Among the methods presented in the embodiments is isolating the two output channels using a transformer or AC blocking diodes and the powering device ground reference is AC coupled to the magnetic stripe reader power circuit preventing interaction between the two functions.

In other transaction processing applications the traditional POS terminal has been replaced with standard platform devices such as mobile and desktop computers mobile phones and tablets. These computers run operating systems such as Microsoft Windows and Linux which are known to have security vulnerabilities. Unlike the traditional POS terminal which has security measures including secure operating systems, only applications that have been pre-tested for security vulnerabilities, anti-tamper devices built into the enclosure along with PCI certification testing, these new platforms are known to have vulnerabilities that may allow for the transaction data to be compromised. In one embodiment, the intelligent security module is located such that the transaction data is collected and secured prior to entering the computer using a portable token reading, security module. The secured data is then transferred to the computer using any of its communication channels including USB, Bluetooth and serial ports.

In other transaction processing applications, the traditional POS terminal has been replaced with multiple device platforms such as mobile phones and desktop computers. In these application the business owner may be required to purchase and maintain multiple POS transaction processing, devices to support the multiple platforms. Each device can require a separate merchant account to process transactions. According to one embodiment of the invention the portable security module is equipped with multiple interfaces such as USB and audio phone jack. Either interface can be selected depending on the current requirement of the transaction processing platform. The POS application running on either device: formats the previously encrypted token data to be compatible with the processor or gateway being used by the POS application.

Encryption, key management and control functions required by the PCI 3.0 SRED standard incorporates varying levels of protection based on the type of data being protected. For example, private and symmetric keys require a higher level of protection than public keys or encrypted data. The security module may include, in one embodiment, a first application microprocessor configured to perform a low-security task on a token information such as decoding the magstripe data and encrypting the data along with other information such as the magstripe warble signature with the public key of the high-security module, wherein the high security task includes one or more tasks from the group including: receiving the data encrypted by the low-security processor and using the high-security processors private key to decrypt the data and reformat the data into a second encrypted format compatible with the POS or financial transaction network.

PCI 3.0 requires that the physical connection between the magstripe read head, the read head analog electronics and the data encryption module be protected from the attachment of data capture devices designed to collect clear text transaction data. In accordance with one embodiment of this invention the read head analog electronics in integrated into the data encryption low-security processor module, which is secured within the magnetic read head.

In accordance with one embodiment of this invention, the processor module monitors a security grid built into the head module protecting the head to processor connections from tampering.

In accordance with one embodiment of this invention the head analog and digital processor module secures the connection between the head and the processor module by injecting a random signal into the magnetic read head. During a read operation the injected signal is summed with the read signal canceling the injected signal and allowing the data to be read.

In accordance with one embodiment of this invention the head analog and digital processor module consists of a custom ASIC. In another embodiment a COTS (commercial off the shelf) processor is used in conjunction with a novel circuit design to provide the required magnetic peak location accurately at a much lower cost than developing a custom ASIC.

In accordance with FIPS 140-2, the requirements and testing procedures for a hardware security module require the physical boundary to be specified prior to testing. If that boundary is specified as the area encompassing the high-security processor and there is no physical connection to the security processor that can be compromised, then the area within the boundary is the only area required to be tested.

Because only the security processor has access to sensitive information, only the secure processor code and hardware require certification and testing for security flaws with any change to the security system. The application processor can be altered with little or preferably no chance of compromise of the security processor, thus reducing the number of re-certifications required and extent of the recertification testing requirements.

The embodiments described herein are not limited to processing and securing token information, and can also be used for source authentication, random number veneration and other hardware security module functions.

The subject of token information processing will now be described in accordance with various embodiments. The token information can have at least a primary account number of a bank card. The token information can also be encrypted by the first processor with a unique key associated with a second microprocessor. In this case, the second microprocessor can be configured to decrypt the token information, determine a correct encryption key based on a merchant identification and to encrypt the token data using the correct encryption key.

In one embodiment, the first processor is a special purpose device suited to reading and decoding and reformatting the token data and the second processor is a special purpose device suited to high security encryption applications hereafter called a HSM.

The token information can also be encrypted by the first processor using the asymmetric public key of the second microprocessor. This limits the scope of keys in the first processor to that of a public key supporting its lower security level. The HSM protects all other keys.

In one embodiment, the first and second processor are in close proximity to each other such as mounted on the same PCB within the magnetic head structure. On first power up of the assembled unit at manufacture the HSM generates a random public/private key pair. It then sends the public key to the first processor which returns a randomly generated symmetric key encrypted using the HSM public key. The HSM then generates a second key pair, encrypts the new public key with the first processors symmetric key and returns the encrypted public key to the first processor which decrypts the public key. The first processor then encrypts a key generation complete message to the HSM which replies with a second key generation complete message encrypted with the first processors symmetric key.

In one embodiment, the first processor and the HSM permanently disable the ability to generate a first shared symmetric key or asymmetric key pair and are considered wed.

In another embodiment, the I-ISM sends the first processor an encrypted DUKPT root or base derivative key using the first processors symmetric, key. The first processor then initializes its DUKPT key generator and discards the root key.

In one embodiment, the second microprocessor is configured to re-encrypt the decrypted token information with a unique merchant key and to send the re-encrypted token data to the first microprocessor.

In one embodiment, the data encrypted by the security processor and output to the financial network for processing is encrypted using a Format Compatible Encryption. Format Compatible Encryption provides output data that maintains the transport format not the clear data format. The length and character set can be changed to provide for additional data to be transmitted. The additional transport data space can be used to hold transaction encryption data such as the DUKPT KSN.

In another embodiment of the present invention, a method for processing bank card transactions may include: receiving a token information: performing a low-security task on the token information using a first microprocessor, wherein the low-security task includes one or more tasks from the group of encryption determination, encryption-decryption request, key management, token information delivery, or transactional data delivery; and performing a security-related task on the token information using a second microprocessor based on a request from the first microprocessor, wherein the security-related task includes one or more tasks from the group of token information authentication, token information decryption, or token information encryption.

In another embodiment, the decrypting step comprises determining a correct decryption key based on a merchant identification, and/or the token unencrypted data and then decrypting the encrypted token data using the correct decryption key. In yet another embodiment, the method includes a procedure to re-encrypt the decrypted token information with a unique merchant key using the second microprocessor and sending the re-encrypted token data to the first microprocessor.

Encrypting the transaction data using the application processor and security processor with a magnetic stripe reader is not a time intensive operation. Decrypting the data from multiple readers simultaneously at the gateway or processor is time critical. A current benchmark for this decryption appliance is to provide for 1000 decryptions per second. Currently servers and HSMs costing tens of thousands of dollars are used to meet this decryption requirement. In one embodiment, the decryption appliance consists of an array of the security processors similar to that used to encrypt the data and the point of swipe. An array of 1000 security processors each providing one decryption per second provides the same throughput at a fraction of the implementation cost. In addition, since the security perimeter is each processor the decryption appliance construction against tampering is greatly reduced.

In yet another embodiment, the security-related task may include one or more tasks from the group of PIN information authentication, PIN information decryption, or PIN information encryption. The method may also include the procedure of: receiving a PIN information; determining whether the PIN information is encrypted using the first microprocessor; decrypting the PIN information using the HSM; re-encrypting the decrypted token information with the decrypted PIN information using the HSM; and sending the re-encrypted token data to the first microprocessor.

In another embodiment according to the present invention, a method for processing bank card transactions includes; receiving token information from a token card; determining whether the token information is encrypted using a first microprocessor; sending a request from the first microprocessor to a HSM to decrypt an encrypted token information; and decrypting the encrypted token information using the HSM processor. The method may also include the step of receiving a PIN information; decrypting the PIN information if it is encrypted re-encrypting the decrypted token information with the decrypted PIN information; and sending the re-encrypted token data to the first microprocessor.

In another embodiment according to the present invention, a secure transaction apparatus configured to process bank card transactions includes: a first microprocessor configured to receive token information from a token card and to determine whether the token information is encrypted; and a second microprocessor configured to decrypt an encrypted token information based on a request to decrypt from the first microprocessor.

In another embodiment according to the present invention, a secure transaction apparatus configured to process financial card transactions includes: a card reader configured to extract token data from a token card, the card reader having a first security module; a user interface module having a third security module; a communication interface coupled to the card reader, the display module, and the user interface. In this embodiment, each of the security modules comprises: a first microprocessor configured to perform a non-security task on a token information, wherein the non-security task includes one or more tasks from the group of encryption determination, encryption-decryption request, key management, token information delivery, or transactional data delivery; and a second microprocessor configured to perform a security-related task on the token information based on a request from the first microprocessor, wherein the security-related task includes one or more tasks from the group of token information authentication, token information decryption, or token information encryption.

The secure transaction apparatus may also include a biometric module configured to collect biometric data from a user, the biometric module having a third security module, wherein the third security module is similar to the first security module.

In one embodiment, the secure transaction apparatus includes a keypad module configured to collect PIN information from a user, the keypad module having a third security module, wherein the third security module is similar to the first security module.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating one example of a transaction network with which the present invention can be implemented.

FIG. 2-2A is a diagram illustrating an implementation of features that can be associated with the invention according to one embodiment of the present invention.

FIG. 2B is a diagram illustrating the use of biometric secured transactions.

FIG. 3 is a diagram illustrating an implementation of features that can be associated with the invention according to one embodiment of the present invention.

FIG. 4 is a diagram of a smart security module according to one embodiment of the present invention.

FIG. 5 is a diagram of a distributed security module according to one embodiment of the present invention.

FIGS. 6-10 are operational flow diagrams illustrating examples of a secure transaction according to one or more embodiments of the present invention.

FIG. 11 is illustrates a transactional process flow according to one embodiment of the present invention.

FIG. 12 illustrates a transactional process flow that can be implemented by a module according to one embodiment of the present invention.

FIG. 13 is a diagram illustrating an example computing, system with which software components can be executed according to one embodiment of the present invention.

FIG. 14 is a diagram of the magnetic head peak detector according to one embodiment of the present invention.

FIG. 14A-14D is a diagram of the magnetic head peak detector according to one embodiment of the present invention.

FIG. 15 is a diagram of single chip three-track reader according to one embodiment of the present invention.

FIG. 16 is a schematic of a single chip three-track reader with USB according to one embodiment of the present invention interface.

FIG. 17 is a diagram of a single chip three-track peak detector according to one embodiment of the present invention.

FIG. 18 is a diagram of the single chip magstripe application processor and single chip security processor

FIG. 19 is a drawing of a tablet token reader accessory according to one embodiment of the present invention.

FIG. 20 is a drawing of a tablet token reader accessory with biometric token reader according to one embodiment of the present invention.

FIG. 21 is a drawing; of token reader with keyboard accessory according to one embodiment of the present invention.

FIG. 22 is a drawing of a tablet token reader accessory with keyboard and biometric token reader according to one embodiment of the present invention.

FIG. 23 is a drawing of mobile phone token reader accessory according to one embodiment of the present invention.

FIG. 24 is a drawing of a mobile phone token reader accessory with biometric token reader according to one embodiment of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for providing a system for facilitating token access in various forms. In one embodiment, the system provides systems and methods for secure token access across a communication medium.

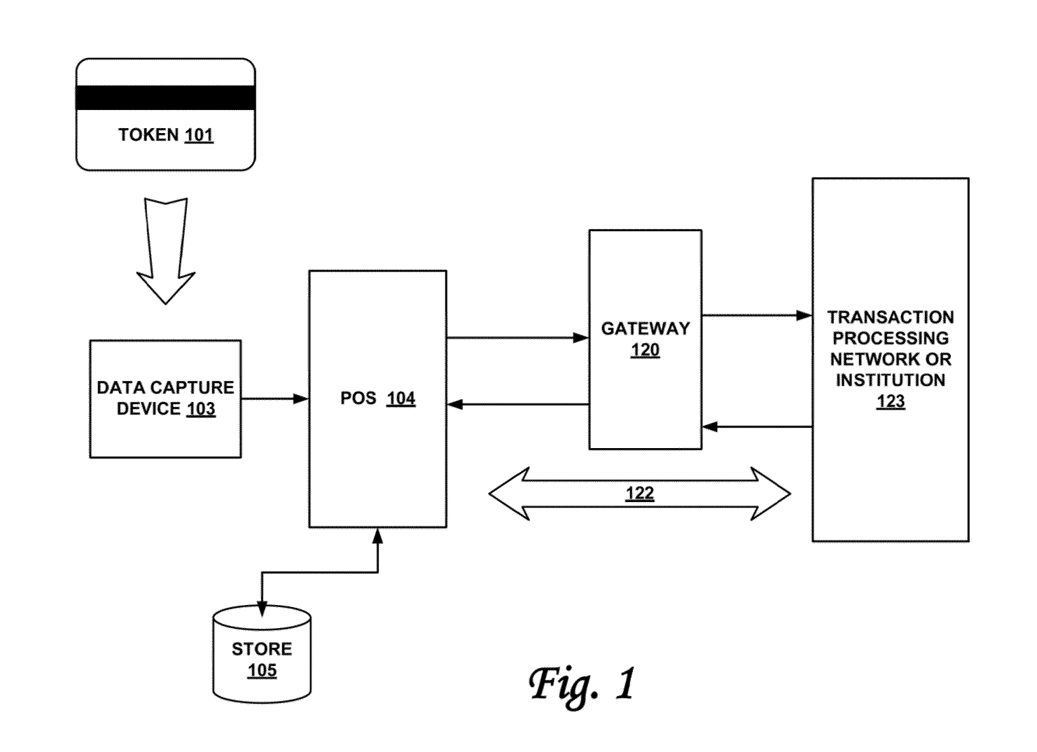

Before describing the invention in detail, it is useful to describe an example environment with which the invention can be implemented. One such example is that of a transaction card network that includes a token used to facilitate purchases or other transactions. FIG. 1 is a diagram illustrating one example of a transaction network 100 with which the present invention can be implemented. Referring now to FIG. 1, transaction network 100 is a token network that can be used to authorize and settle purchases of various goods and services. Illustrative examples of implementations of such a transaction network are the charge card, credit card and debit card transaction networks used to facilitate purchase transactions and banking transactions by and among merchants and other businesses, banks and other financial institutions and individuals. Generally speaking, in such a transaction network., the customer utilizes a charge card, credit card, debit card or other token as a symbol of his or her identity, or as an identification of the account he or she would like to have charged for the transaction. The token is typically accepted by the merchant, the account information read, and used to credit the transaction. Merchants may ask for a driver's license or other form of identification to verify the identity of the purchaser in conjunction with the token issued.

The token data in this example is then sent to the appropriate financial institution or institutions, or other entities for processing. Processing can include, in one or more steps, authorization, approval and settlement of the account. As the example in FIG. 1 illustrates, a token 101 can be used by the customer to facilitate the transaction. As stated, in this example environment, examples of token 101 can include a charge card, debit card, credit card, loyalty card, or other token that can be used to identify such items as the customers, their account, and other relevant information. As a further example, a card such as a credit or debit card can include various forms of technology to store data, such as a magnetic stripe technology, processor or smart card technology, bar code technology or other technology used to encode account number or other identification or information onto the token. As such, a properly encoded token can include various forms of information relating to the purchaser such as, for example, the identity of the purchaser, information associated with the purchaser's account, the issuing bank or other financial institution, the expiration date, and so on.

As only one example of a token 110, a credit card can be used with a conventional magnetic stripe included on one side thereof. Conventional magnetic stripes can include three tracks of data. Further to this example, the ISO/IEC standard 7811, which is used by banks, specifies: that track one is 210 bits per inch (bpi), and holds 79 six-bit plus parity bit read-only characters; track two is 75 bpi, and holds 40 four-bit plus parity bit characters; and track three is 210 bpi, and holds 107 four-bit plus parity bit characters. Most conventional credit cards use tracks one and two for financial transactions. Track three is a read/write track (that includes an encrypted PIN, country code, currency units, amount authorized), but its usage is not standardized among banks.

In a conventional credit card token, the information on track one is contained in two formats, Format B includes the following:
Start sentinel—1 character
Format code=“B”—1 character (alpha only)
Primary account number—up to 19 characters
Separator—1 character
Country code—3 characters
Name—2-26 characters
Separator—1 character
Expiration date or separator—4 characters or 1 character
Discretionary data—enough characters to fill out maximum record length (79 characters total)
End sentinel—1 character
Longitudinal Redundancy Check (LRC), a form of computed check character—1 character

The format for track two can be implemented as follows:
Start sentinel—1 character
Primary account number—up to 19 characters
Separator—1 character
Country code—3 characters
Expiration date or separator—4 characters or 1 character
Discretionary data—enough characters to fill out maximum record length (40 characters total)
LRC=1 character

Although a credit card with magnetic stripe data is only one example of a token that can be used in this and other environments, this example environment is often described herein in terms of a credit card implementation for clarity and for ease of discussion.

Upon entering into a transaction, a merchant may ask the customer to present his or her form of payment or credentials, which in this example is the credit card. The customer presents the token 101 (e.g., credit card) to the merchant for use in the transaction POS 104. In one embodiment, the credit card can be swiped at a magnetic stripe reader or otherwise positioned to be read by the data capture device 103. The swipe of the credit card across the magnetic stripe read head inputs a signal into the magstripe reader representative of the magnetic flux transitions pattern encoded onto the magnetic stripe. The read electronics detects the relative locations of the flux transitions and converts the patterns into the corresponding card data values. The data is generally output as ASCII text values of the credit card data. In the current example where a credit card utilizing a magnetic stripe is the token 101, data capture device 103 can include any of a variety of forms of magnetic stripe readers to extract the data from the credit card. In other embodiments or implementations, other forms of data capture devices 103, or readers, can be used to obtain the information from token 101. For example, bar code scanners, smart card readers, RFID readers, near-field devices, and other mechanisms can be used to obtain some or all of the data associated with token 101 and used for the transaction.

The data capture device is in communicative contact with a terminal or point of sale (POS) 104, which can include any of a number of terminals including, for example, point of access terminal, an authorization station, automated teller machine, computer terminal, personal computer, work stations, cell phone, PDA, handheld computing device and other data entry devices. Although in many applications the data capture device 103 is physically separated, but in communicative contact with, the POS 104, in other environments these items can be in the same housing or in integrated housings. For example, terminals such as those available from companies such as Ingenico, Verifone, Apriva, Linkpoint, Hypercom and others can be used.

Continuing, with the credit card example, the customer or cashier can swipe the customer's credit card using the card-swipe device, which reads the card data and forwards it to the cashier's cash register or other POS 104. In one embodiment, the magnetic stripe reader or other data capture device 103 is physically separated, but in communicative contact with, the POS 104. In other environments, these items can be in the same housing or in integrated housings. For example, in current implementations in retail centers, a magnetic stripe reader may be placed on a counter in proximity to a customer, and electronically coupled to the cash register terminal. The cash register terminal may also have a magnetic stripe reader for the sales clerk's use.

The customer may be asked to present a form of ID to verify his or her identity as imprinted on the token 101. For other transactions such as debit card transactions, the user may be required to key in a PIN or other authentication entry.

Continuing with the current credit card example, the POS 104 can be configured to print out a receipt (or may display a signature page on a display screen) and the customer may be required to sign for his or her purchases, thus providing another level of authentication for the purchase. In some environments, POS 104 can be configured to store a record of the transaction for recordkeeping and reporting purposes. Further, in some environments, a record of the transaction may be kept for later account settlement.

Typically, before the transaction is approved, POS 104 seeks authorization from one or more entities in a transaction processing network 123. For example, the merchant may seek approval from the acquiring bank, the issuing bank, a clearing house, or other entity that may be used to approve such transactions. Thus, depending on the token type, institutions involved and other factors, the transaction processing network 123 can be a single entity or institution, or it can be a plurality of entities or institutions. As a further example, in one embodiment, transaction processing, network may include one or more processors or clearing houses to clear transactions on behalf of issuing banks and acquiring banks. The transaction processing, network also include those issuing banks and acquiring banks. For example, one or more entities such as Global Payments, Visa, American Express, and so on, might be a part of transaction processing network. Each of these entities may have one or more processing servers to handle transactions.

In some instances, the approval may also constitute the final settlement of the transaction resulting in the appropriate funds being transferred to consummate the transaction. In other embodiments, however, the authorization may simply be an authorization only and actual account settlement can take place in a subsequent transaction. For example, authorization may verify the validity of certain information such as the account number, expiration date, customer name, and credit limit to determine whether to approve the transaction. Settlement may be accomplished when a series of one or more approved transactions are sent to the appropriate institution(s) for transfer of the funds or other account settlement.

As illustrated in FIG. 1, a gateway 120 can be included to facilitate routing of transactions, authorizations and settlements to and from the appropriate entity or entities within the transaction processing network 123. For example, where a merchant accepts credit cards from numerous different institutions, the gateway can use the BIN (Bank Identification Number) obtained from token 101 and passed to gateway 120 to route the transaction to the institution(s) associated with the given BIN. As illustrated by flow arrow 122, not all transactions are necessarily routed through a gateway 120. Transactions may take other paths to the appropriate entity or entities in the transaction processing network 123. Additionally, the term gateway as used herein is not restricted to conventional gateway applications, but is broad enough to encompass any server or computing system configured to perform any or all of the described functionality. The term gateway is used for convenience only.

Although transaction processing network 123 is illustrated using only one block in the example block diagram environment of FIG. 1, this block can represent a single entity to which the transaction is routed for authorization or settlement, or a network of entities that may be involved with authorization and settlement. Communications among the various components in the example environment can be wired or wireless transmissions using a variety of communication technologies formats and protocols as may be deemed appropriate for the given environment. As one example, the currently available credit card processing network and protocol structure can be utilized as the environment with which embodiments of the invention can be implemented. In fact, in one embodiment of the invention, various features and functions of the invention can be implemented within current or legacy transaction processing networks to provide enhanced features while reducing the level of change or upgrade required to the networking infrastructure.

Having thus described an example environment, the present invention is from time-to-time described herein in terms of this example environment. Description in terms of this environment is provided to allow the various features and embodiments of the invention to be portrayed in the context of an exemplary application. After reading this description, it will become apparent to one of ordinary skill in the art how the invention can be implemented in different and alternative environments.

As mentioned, before the transaction is approved, POS 104 seeks authorization from one or more financial institutions in network 123. However, based on the architecture of network 100, neither POS 104, gate 120, nor the financial institutions in network 123 can detect in real-time if data capture device 103 has been compromised. For example, device 103 can be compromised in such a way that data from token card 101 can be captured and stored using an unauthorized and altered data capturing device that looks and functions in the same way as an original and authorized data capturing device 103. The unauthorized-altered device can be switched with the original-authorized data capturing device 103 from unsuspecting retailers. This can be done by a misaligned employee of the retailer or by individuals posing, as authorities for one of the network payment providers such as VISA, MasterCard, or American Express. Typically an unauthorized, altered data capturing device 103 is configured to capture token data from token card 101 and the personal pin, if any, for token card 101. The captured data is then stored and transmitted to the fraud perpetrators, and is then used create a clone card or to make illegal online transactions.

Another example of an attack on a network similar to transaction network 100, is a relay attack on a chip-and-pin network. In the relay attack, instead of connecting to the customer's hank via gateway 120 or communication channel 122, the unauthorized, altered data capturing device 103 connects to a computer in the retailer such as a restaurant or to a remote computer and relays the captured token data to the computer. A second remote computer in communicative contact with the first computer in the restaurant can be located at another retailer such as a jewelry store across town. The second computer then receives the captured data from the legitimate card in the restaurant and reprograms a modified bankcard with the captured data. The chip in the modified bankcard is typically removed or altered to be in communicative contact with the second computer. In this way, once the customer in the restaurant has entered their PIN, the fraud perpetrator in the jewelry store puts the knock-off card in the jewelry store's terminal. All transactions from the jewelry store are relayed between the modified bankcard, the two computers, and the unauthorized terminal to the legitimate card. This establishes a link between the jewelry store's terminal to the customer's bank. Thus, instead of paying for example for a $30 meal, the customer is defrauded out of thousands of dollars for jewelry purchases. As can be seen, during this relay attack the perpetrator does not need to hack into an systems or run any decryption, as data is simply being relayed from one terminal to another.

The current architecture of payment networks like, are not configured to detect the above examples of fraud in real-time. Typically, the fraud detection comes after the transaction is made by looking at statistical data or after the customer notified his or her bank that unauthorized transactions have occurred. The intelligence to detect authorized transactions or hacked terminals, if any, of such networks are located at network 123. This, however, is too late to stop illegal transactions as they are occurring.

Traditional financial networks like also cannot perform token and PIN data authentication locally (near the POS), meaning the token and PIN data cannot be authenticated without first transmitting the token and PIN data over the network to the financial institution (e.g., issuing hank) for authentication. For example, in VisaNet, the token and PIN data have to go through one or more gateways and/or data aggregators before arriving at the issuing bank, which then forwards the data to a decryption appliance for verification. Because of the route the token and PIN data have to navigate before arriving at the decryption appliance, there is an inherent delay in the authentication process. Thus, token and PIN data cannot be authenticated locally in real-time. This authorization process is disadvantageous for the retailer because the authentication process is controlled by the payment network instead by the retailer or the cards issuing bank.

Additionally, traditional financial networks maintain control of the authorization process currently used by most retailers by requiring all transaction data to be routed through their networks. This is accomplished by requiring the retailer to use a certified card terminal without the intelligence or the ability to extract necessary information from the token card to enable the card terminal or a POS terminal of the retailer to perform authorization and settlement directly with the issuing bank, A conventional card terminal is configured in such a way such the retailer can only communicate with the traditional payment network or with retailer's bank directly, which in turn sends the authorization and settlement request to the issuing bank. For example, in the Discover Network, to obtain authorization after a card holder presents the card to the retailer, the following steps occur: 1) retailer sends transaction data to an acquiring bank (retailer's bank); 2) the acquiring, bank sends the transaction data to the issuing bank via the Discover Network; 3) the issuing bank then authenticates the card and authorizes the transaction; 4) the issuing bank sends an authorization message to the retailer via the acquiring bank. As described above, the payment networks such as VisaNet and Discover Network maintain control of the authorization and payment process by controlling the way transaction data is routed.

The present invention is directed toward a system and method for securing transaction with security and intelligence at the front end or edge of the network. The front edge of the network can be defined as any point upstream of gateway 120. In one specific embodiment, the front edge of the network is any point upstream of POS 104, but including POS 104.

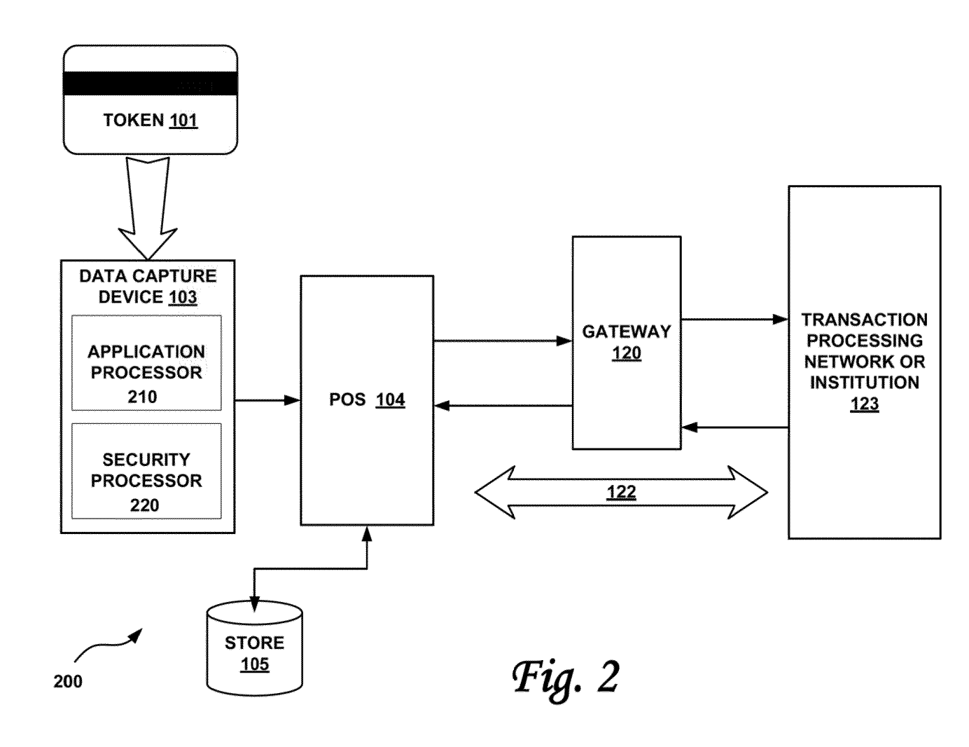

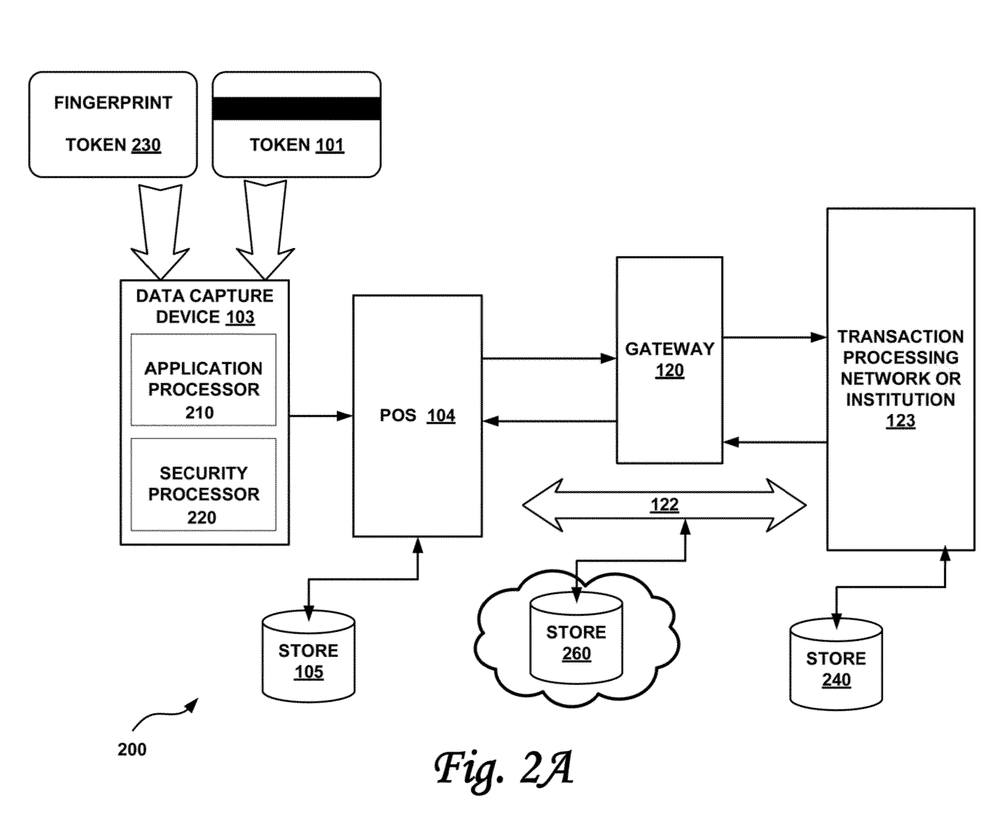

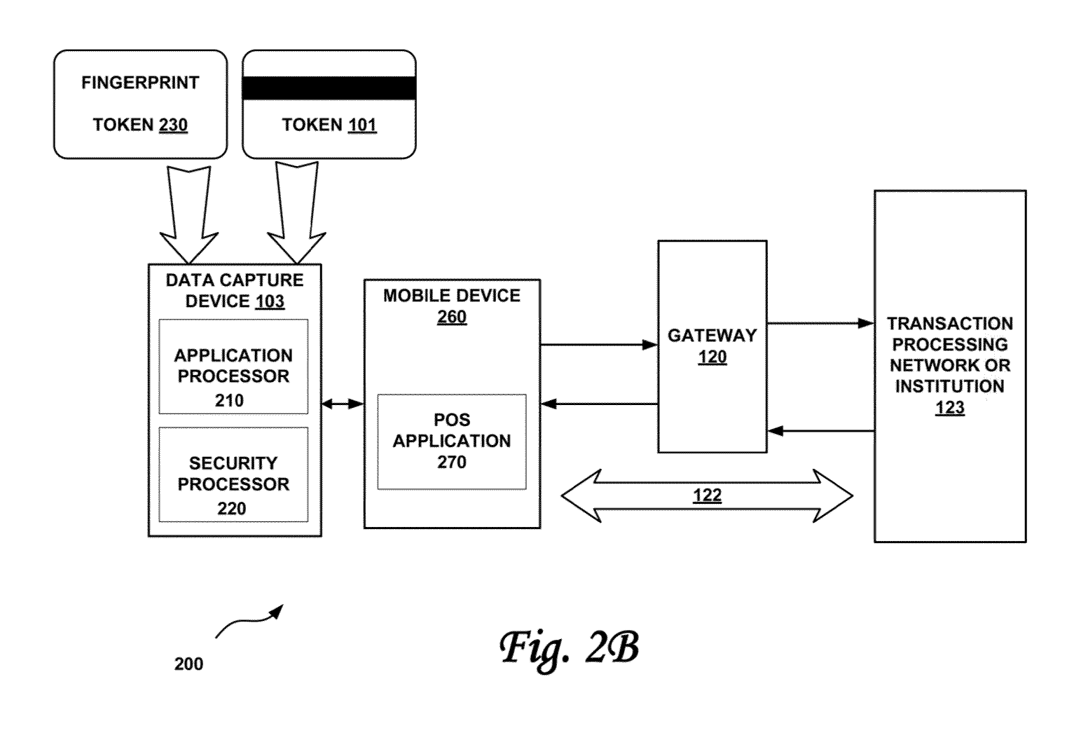

FIG. 2 illustrates an example of a transaction network 200 with intelligence at the front end according to one embodiment of the present invention. Referring now to FIG. 2, similar to network 100, network 200 includes token 101, data capture device 103, POS 104, gateway 120, and network or financial institution 123. However, network 200 also includes an application processor 210 for interpreting the input data, formatting the data for the POS application, generating a data format compatible with the POS, point of entry encrypting the data for transmission to the security processor and a security processor module 220, for providing point of entry decryption, transaction network data reformatting and re-encryption, key storage. Application processor 210 provides all external connections including the clear text data input from the load input device such as magnetic head or keyboard and all communications with the POS 104, or gateway 120 or transaction processing network 123. In one embodiment, the data capture device 103 accepts magnetic flux transitions representing the card clear text data from the input token, converts the data into the representative card data, encrypts the data, reformats the card data as magnetic stripe transition patterns and then outputs the data in a format compatible with the output from a magnetic read head. The output is then input to a magstripe reader as the output from a standard magstripe read head. The encrypted data being of a compatible format to the original card data.

In one embodiment, encryption information such as a Key Serial Number (KSN) is output in a compatible format to magstripe data with the encrypted card data.

In one embodiment, the data capture device 103 accepts clear text data from the input token and encrypts the data with a DUKPT derived single use key and transmits the encrypted data along with the application specific data format to the security processor 220. The security processor 220 decrypts the data and re-encrypts the data using the POS 104, gateway 120 or transaction processing, network 123 keys and encryption format specified by the application processor 210. The re-formatted data is then returned to the application processor 210 to be included in the data packet to be sent to the POS 104, or gateway 120 or transaction processing network 123 for processing.

In one embodiment, the security processor 220 re-encrypts the data as compressed ISO 7813 financial transaction data using the maximum data count for each track and the data is output as ISO 7813 magnetic stripe data. The data compression along with using the maximum data count allows for additional information to be included with the original transactional data.

In one embodiment, the security processor 220 re-encrypts the data using the largest radix supported by the data transport. In the case of 8 bit binary data the radix of 256 is used, in the case of upper case alphanumeric with punctuation base 42 is sed.

In one embodiment, some of the additional data space created through the compression is used to send the DUKPT KSN with the data.

In one embodiment, some of the additional data space created through the compression is used to send other information used to authenticate the token.

In one embodiment, the PAN which is 14 to 16 digits in length is expanded to the maximum field length of 19 digits. The added digits are placed after the first six digits and prior to the last 4 digits of the PAN to allow for band rounding and receipt printing functions. The digits placed in the expanded data fields are used to convey encryption and status information such as the type of encryption being used and part of the KSN for decryption purposes.

In one embodiment, the application processor send the encrypted transaction data to the POS 104, or gateway 120 or transaction processing network 123 for processing and in addition sends related encryption information such as the DUKPT KSN and other information to authenticate the transition as a separate data packet to the POS 104, or gateway 120 or transaction processing network 123 for processing the encrypted data.

In one embodiment, the application processor 210 can specify that the security processor 220 format the encrypted data in a format preserving or a format compatible structure for a specific target. The target maybe the POS, the gateway, the processor, or any other target for the encrypted data. In which case the application processor 210 encrypts the card data using the security processors 220 shared or public key, then sends the encrypted data to the security processor 220 where the data is decrypted, reformatted into the specified format and re-encrypted using the using the targets shared or public key of the specified target.

In one embodiment the application processor 210 and security processor 220 are located in the same physical processor. In one embodiment, the processor is configured with multiple cores and the application and security functions are separated by processing cores. In another embodiment, the application and security functions are separate tasks within in a single core processor.

FIG. 2A illustrates an example of a transaction network 200 with intelligence at the front end according to one embodiment of the present invention. Referring, now to FIG. 2A, a fingerprint reader 230 has been added as a second token reading device. According to one embodiment of the present invention, the fingerprint is uses as the primary token in place of the magstripe token. In one embodiment the fingerprint token is formatted in a compatible format with the current magstripe token format message to the POS 104. The POS 104 matches the fingerprint token 230 with its corresponding financial network transaction token using store 105. The POS then forwards the financial token to the gateway 120 and processing institution 123 for authorization.

In one embodiment the fingerprint token is generated from the operator of the data capture device 103 to verify the operators credentials to process a magstripe transaction. The token is sent to the POS 104 for authentication of the POS user using the store 105. The POS 104 enables or disables the magstripe token reader 103 to process to magstripe transaction. In on embodiment, the customer is given the option to use a magstripe token 101 or a fingerprint token 230 to imitate the transaction.

In one embodiment, the customer supplies a fingerprint token 230 which the POS forwards the token to processing network 123 via the to the gateway 120 or the alternate communication channel 122 which uses the token to lookup the associated transaction token data in store 240. The resulting transaction token data from the store 240 is used to authorize the transaction by the processing institution 123 and the results returned to POS 104 via the gateway 120 or the secondary communication channel 122. In one embodiment the fingerprint token 230 is translated to a valid transaction token via a cloud based store 260.

In one embodiment the fingerprint token 230 is captured at the time of the transaction, and combined with other token data captured 101, along with POS transaction data from the mobile device 260 and the POS application 270, along with data supplied by the transaction-processing network 123. The combined data encrypted within the data capture device 103 and forwarded to the mobile device 260 and gateway 120 to be processed by transaction processing network 123

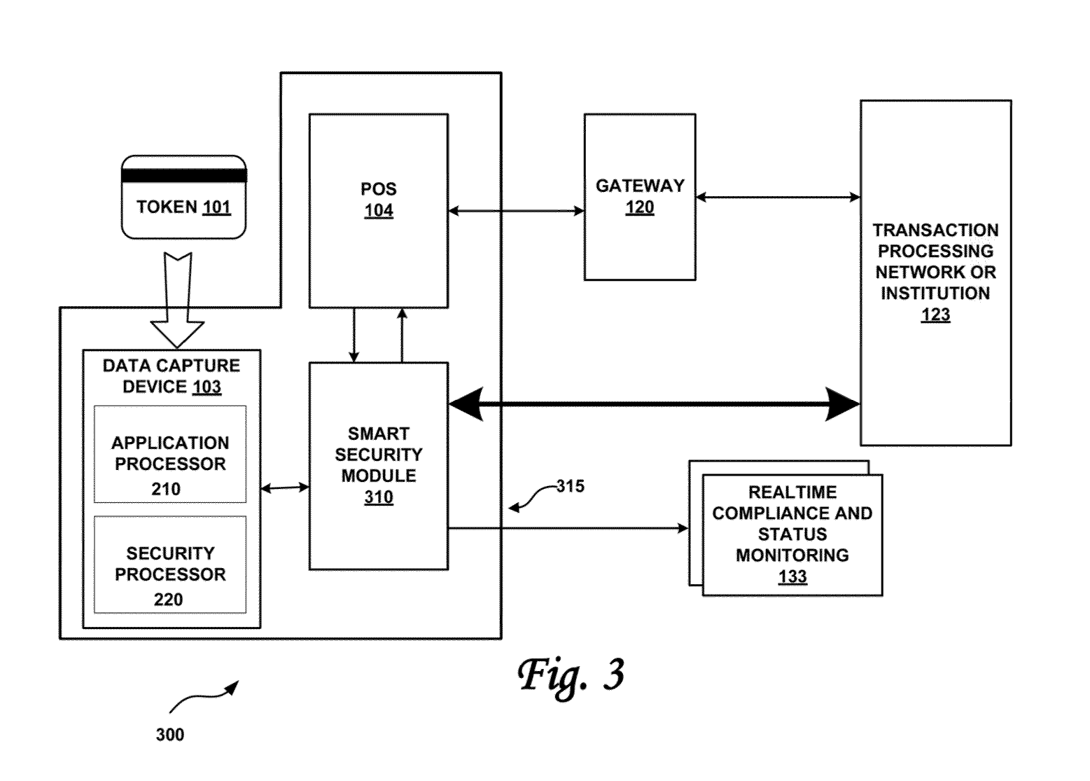

FIG. 3 illustrates an example of a transaction network 300 with intelligence at the front end according to one embodiment of the present invention. Referring now to FIG. 3, similar to network 200, network 300 includes token 101, data capture device 103, POS 104, gateway 120, and network or financial institution 123. However, network 300 also includes a smart security module 310, fir providing real-time compliance and status monitoring, 333, which can be a separate component as shown in FIG. 2. Smart security module 310, POS 104, and data capture device 103 can also be implemented as a single module 315. Smart security module 310 is a module that has the intelligence to monitor and authenticate token and pin data locally. It can also be configured to communicate directly with a financial institution or network (i.e. can bypass VisaNet or Discover Network).

In one embodiment, security module 310 is configured to perform real time monitoring of transactions as they occur as indicated by block 333. This can be done by having the intelligence built into the security module 310. In conventional networks, real time monitoring and authentication cannot be done because transactional data has to travel through gateway 120 or other data aggregator before reaching network 123 where the intelligence of the network is located. In contrast, the intelligence of network 300 is located at the edge of the network, security module 210., where payment transaction occurs.

As shown in FIG. 3, security module 310 is configured to receive token data from data capture device 103. Token data can be sent to security module 310 encrypted, particularly if data capture device 103 is separately located from security module 310. Alternatively, token data from data capture device 103 can be sent to security module 310 unencrypted or in a clear text format. This may be done when data capture device 103 and security module 310 are located in a same secured housing such as, for example, a housing encased in epoxy and steel, or other tamper-safe materials or combination of materials to provide safeguards against tampering.

In one embodiment, pins or other electrical contacts can be provided, at predetermined locations of a secured housing. The epoxy, resin, or other potting material can be a conductive material, thus creating a current path between and among the pins. Control logic can be provided inside of the housing for detecting changes in resistance across various paths between various pairs of pins. Thus, if an attempt is made to open the device or to probe the circuitry to obtain keys, algorithms or other encryption information, the resistance between one or more pairs of contacts will be changed. As a result of the change in resistance, the encryption engine within the secured housing can be configured to be self disabling encrypted data can no longer be generated or is invalid).

Certain types of token card such as an ATM card, debit card or a chip-and-pin card may require a PIN to be entered. The PIN can be encrypted by an encrypting engine in a secure PIN pad (not shown) prior to being transmitted to security module 210 using an encryption key stored in memory or a key generated by an encryption algorithm. In one embodiment, the PIN is encrypted using some or all of the token data extracted from token card 101. Once the PIN is encrypted, the PIN pad transmits the encrypted PIN to security module 310. Token data extracted from token card 101 can be similarly encrypted using a key stored in memory or a key generated with an encryption algorithm.

PIN and token data encryption might be required especially where the data capture device 103 is separate from security module 310. In one embodiment, where data capture device 103 and security module are part of module 315 or a part of the same hardware security module (HSM), PIN and token data transmitted to security module are encrypted even though data capture device 103 and security module 310 are within the same housing. In this way, even if the housing of module 315 is tampered with, clear text data of the PIN and token data cannot be retrieved simply by tapping into the transmission line or other interface between the data capture device 103 and security module 310.

Once security module 310 receives data from data capture device 103, security module 310 may perform PIN authentication or other identity authentication using locally stored authentication data. In one embodiment, the authentication data can be stored in a remote server upstream of gateway 120 or on a network that can be accessed by smart security module 310. Alternatively, the authentication data can be stored within security module 310.

In one embodiment, the security module 210 receives the PIN from the keypad where the PIN is encrypted with a symmetric key algorithm such as, for example, TDES or AES using a shared key. The Security module 310 decrypts the PIN and then re-encrypts it using, for example, one of the DUKPT encryption formats for transmitting the PIN along with the required PAN information retrieved for the token when the token is swiped for authorization using the processor's PIN keys. In one embodiment, the POS 104 receives the encrypted PAN information from the token and the PIN from the keypad and requests the security module 310 to decrypt the portion of the PAN required for the DUKPT PIN encryption. In yet another embodiment the POS 104 encrypts the PIN using the previously encrypted PAN, which is sent to the transaction processing network 123 where the PIN is decrypted using the processor PIN key and then the PAN is decrypted and the PIN verified.

In one embodiment the, security module 310 is configured to accept commands directly from the transaction processing network 123. Once the command has been authenticated, the security module 310 keys and operating parameters can be updated or changed. In addition, the application processor code and security processor code can be updated directly from the transaction processing network 123. In another embodiment the security module 310 is configured to send compliance and status monitoring information to the merchant, the processing institution, the issuing institution, or compliance and status monitoring institution providing real time monitoring fir compliance verification as shown in block 333.

In yet another embodiment, security module 310 is configured to authenticate the token card. For example, this can be accomplished by analyzing physical properties of the token card such as, for example, magnetic signature or noise of the data read from the magnetic stripe of the card. Security module 310 may also use other authentication techniques such as warble, jitter, remnant noise or other authentication techniques. Authentication can be done by comparing the cards detected signature against a previously stored signature for the card. One or more of these authentication techniques are described in detail in U.S. Pat. No. 6,260,146, which is incorporated herein by reference in its entirety. If both of the signatures match within some predetermined level of statistical probability, then the card can be flagged as authentic. Security module 310 may also authenticate the token card by analyzing where the card has been used previously. This may be done locally or remotely. For example, once security module 310 obtains the token card's information (e.g., physical characteristics, account number, etc.) it may query a database for the same card information to see where the card was recently used. The database may be a remote or a local server that can be assessed by security module 310. Alternatively, secure module 310 can send the card information to a remote server where a database is queried for the same card information to see where the card was recently used. In any case, security module 310 may flag the card as stolen or a clone card if it observes abnormal activity such as simultaneous use of the card in two separate locations, recent use in another state or country, etc.

In one embodiment, token card 101 can be a retailer specific issued card such as a payment card, loyalty card or other card. The retailer issued card may be, for example, a smart card with an RFID chip or tag or other processor or processor-like capability. The retailer issued card may have a PIN associated to the account number of the card. In this way, the retailer can perform authentication of the card locally. Local authentication offers several realizable benefits: authentication can be done immediately at the front edge of the network, thus reducing or eliminating the potential for fraud; and the retailer can execute loyalty, customer service, or data aggregation programs locally because the retailer has control of the authentication and identification processes. In a conventional network, a retailer cannot issue its own unique token card (e.g., a customized RFID card to implement a loyalty or other program), without first obtaining adoption from all of the issuing banks.

In one embodiment, token 101 is a smart card with a microprocessor or an RFID card. The smart card can be a store credit card such as, for example, a retailer-branded card or a retailer issued credit card. When a cardholder makes a purchase with the retailer-issued card, local authentication of the card and the PIN can be done by secure module 310. Alternatively, secure module 310 may authenticate the card and the PEN directly with issuing bank via network 200. For example, secure module 310 may authenticate the card by analyzing the card's physical characteristics and then verify the PIN with the issuing bank, if the PIN authenticating data is stored by the issuing bank. In the local authentication example, once the cardholder's account is locally verified, the store may identify the cardholder's identity, analyze the cardholder's shopping history and behavior, etc. using stored information associated to the cardholder's account number. In one embodiment, the cardholder's name can be transmitted and display on POS 104. In this way, the retailer's associate may properly greet the cardholder, for example. In another embodiment, the cardholder's shopping history can be analyzed and a credit or bonus may be offered to the cardholder at POS 104.

In one embodiment, once the sale is finalized and the total amount of money to be charged to the cardholder's account is determined at POS 104, security module 210 may transmit an encrypted transaction data stream that includes data such as the account numbers of the cardholder and the retailer, and the total amount of the transaction to the retailer's financial own network. In this way, the retailer can avoid using traditional financial network such as VisaNet NOVA network, or Discover Network thus avoiding additional transaction fees. Alternatively, security module 310 can be configured to use a traditional network such as VisaNet or other financial networks for settlement, compliance and, marketing and POS status information can be sent directly to the appropriate sources, giving a real time view of the transaction. As can be seen, network 300 allows a retailer to have unprecedented flexibility. With network 300, a retailer may locally authenticate token and PIN data and may execute loyalty or other customer service programs using its own unique credit card without obtaining prior approval from the issuing banks such as VISA or MasterCard.

Security module 310 may also be used to authenticate data capture device 103 to determine whether device 103 is the original certified device or a cloned device configured to steal token and PIN data. This can be done by analyzing the encrypted token or PIN data that has been encrypted with a unique identification number assigned to data capture device 103 or to the retailer that is hosting the data capture device 103. For example, the unique retailer's identification number or serial numbers of data capture devices in the retailer can be programmed into module 310. In this way, if the original data capture device 103 is removed from the retailer and is replaced with a clone, security module 310 would be able to recognize the cloned device by comparing the encrypted identification number with the stored retailer or device identification number. The identification number may be a device serial number or a randomly generated number assigned to the device.

In one embodiment, module 315 can be configured to encrypt transactional data using a unique retailer identifier such that when the settlement occurs at the end at network 123, the credit will always be transferred the retailer that rightfully owns module 315. In this way, when a theft of module 315 occurred and wherever module 315 ultimately resides, the credit during the final settlement will go to the original retailer's bank. For example, if module 215 is wrongfully removed from a grocery store and is relocated to a sporting good store, in an attempt to hack into module 315, any transactions processed by the stolen module (assuming local card and PIN authentication is not at play) at the sporting good store will ultimately credit the grocery store when final the settlement occurs. This is because module 315, in the example above, has been configured to encrypt transactional data with grocery store account number and therefore all settlements will be credited to that account. Additionally, because data capture device 103 and secure module 310 are within the same secured housing, the data capture device cannot be cloned.

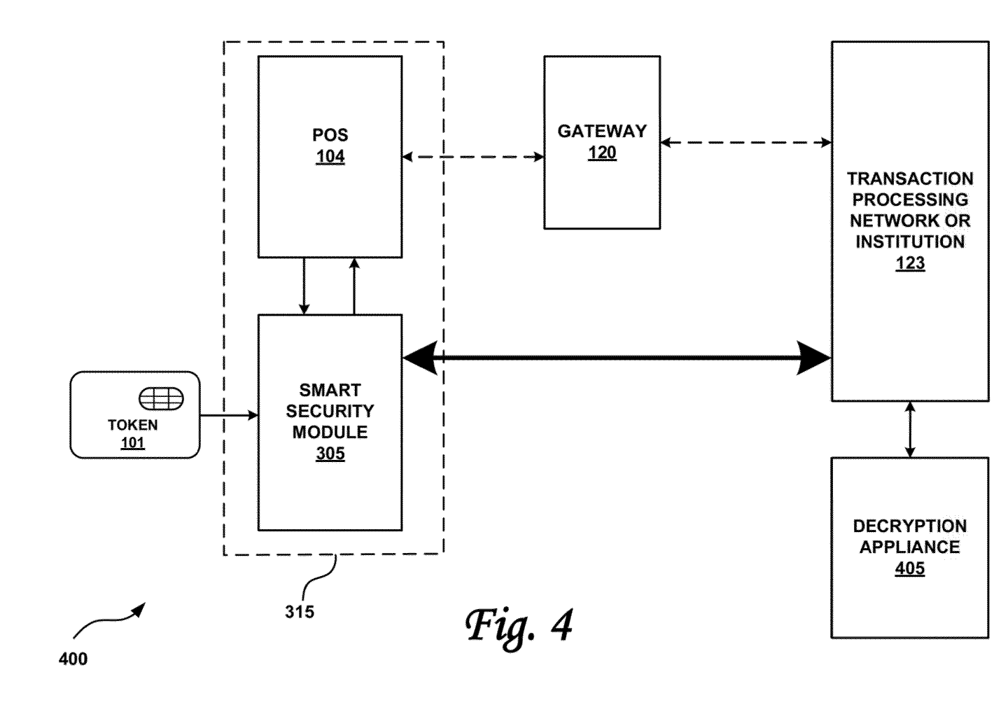

FIG. 3 illustrates a transaction network 400 according to one embodiment of the present invention. Referring now to FIG. 4, network 400 includes smart module 305 that is configured to extract token data from token card 101 and perform local authentication. In one embodiment, smart module 305 includes a token card scanner (not shown) similar to data capture device 103 and a security module 210. The token card scanner may be a magnetic card scanner, an RFID card scanner, a combination of both, or other token reader technology. Smart module 305 may also include a keypad not shown) or a graphical user interface (not shown) to allow the cardholder to enter the PIN for the card if required. The security module 210 inside of smart module 305 can have the same functionalities as previously described in network 300. Security module 210 allows smart module 305 to authenticate the PIN and token data locally without having to transmit the PIN and token data to an issuing, bank in network 123 for verification. Conventionally, network 123 uses a decryption appliance 405 to authenticate the PIN and token data received from POS 104. Smart module 305 bypasses this downstream and non real-time authentication process and does it locally and in real time using smart security module 210 right at the from end of the payment network.

In one embodiment. POS 104 and smart module 305 can be implemented as a single module 315. Thus, module 315 may include a token card scanner, a cash register, a display, a graphical user interface, a keypad, a security module 210, and other biometric authentication devices such as, for example, a fingerprint scanner. In one embodiment, each of the individual devices within module 315 includes its own security module 210 even though all of those devices are housed within a single secured housing. In this embodiment, each of the devices within module 315 has its own decryption and encryption engine, thus each device may communicate with each other with encrypted data. In this way, if the secured housing of module 315 is compromised, the hacker will not be able to gain access to any clear text format data. Further, if one of the devices of module 315 (i.e., the user interface) is hacked, the hacker will not be able to gain access to other devices because each of the devices has its own security module 210. The architecture of security module 210 will prevent a hacked device, for example, hacked a keypad, to gain access to the encryption engine of the card scanner. This distributed network security architecture will be further described in detail below.

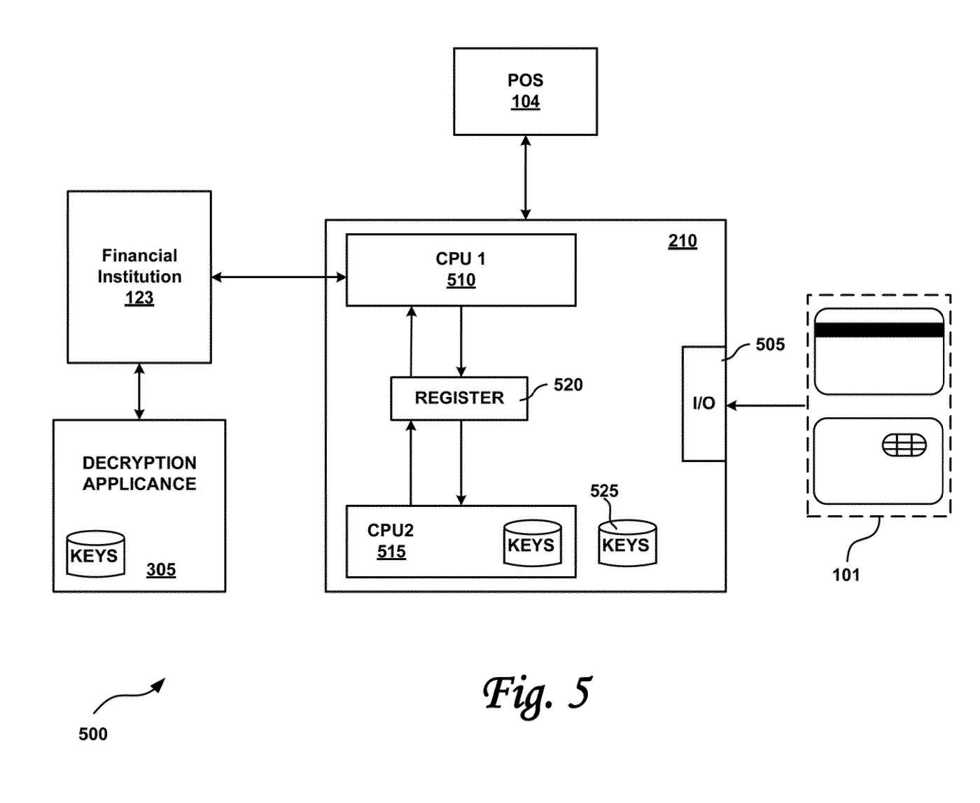

FIG. 5 illustrates a security module 210 being implemented in a transaction network 500 according to one embodiment of the present invention. Transaction network 500 is similar to networks 300 and 400, but with components of security module 210 shown in detail. Referring now to FIG. 5, security module 210 includes an I/O port 505, a first microprocessor (CPU) 510, a second CPU 515, a register 520, and memory 525 for key storage. I/O port 505 can be a magnetic stripe card scanner or an RFID card scanner or a combination of both. ISO port 405 may also includes a key pad or other user interface to allow a cardholder to enter the PIN data or a signature when required. In one embodiment. I/O port may include a biometric device such as, for example, a fingerprint scanner. The data output of I/O port can either be encrypted or unencrypted. In one embodiment, the data output of I/O port is encrypted with an encrypting engine embedded within I/O device 505.

Security module 210, in this embodiment, has two independent processors. In one embodiment, each processor is assigned with specific duties and cannot perform any functions outside of its original scope. In one embodiment, CPU 410 (the first CPU) main functionalities include non-security tasks such as: perform key management such as communicating with an external decryption appliance to build unique keysets for various to types of token card; perform general data processing such as sending and receiving token, pin, and transactional data; encryption determination such as determining whether a token information is encrypted; encryption-decryption request; and enable and disable overall encryption functionalities of module 210. The main functionalities of CPU 515 may include performing high-level security tasks such as decryption and encryption, keys storing, authenticating token and PIN data, and executing transactional commands. This allows CPU 515 to be independent of CPU 510. Also, since security tasks are performed by CPU 415, CPU 510's firmware and other software functions can be updated routinely without having to re-certify CPU 515 or the entire module 210.

In one embodiment, CPU 510 and CPU 515 communicate via a register 520. Register 520 can be configured to allow only certain requests to CPU 515 from CPU 510. In this way, the number of functions CPU 510 can request CPU 515 can be strictly controlled and limited. This architecture may prevent a hacker from gaining access to the encryption engine within CPU 515 if other component of security module 210, such as CPU 510 or 110 device 505 is compromised. For example, if CPU 510 is compromised, a hacker will not be able to send a command to CPU 515 instructing it to accept new keys or to reset the current keys. In one embodiment, CPUs 510 and 415 are fabricated on a single silicon die (not shown). The dual processor die may have an island of material separating CPU 510 from CPU 515. The dual processor die may also include a register that functions as a single means of communication between CPUs 510 and 515. In this way, the functionalities of each CPU can be separated.

Upon receiving data from I/O device 505. CPU 510 may determine whether the received data is encrypted or not. If the data received is encrypted. CPU 410 may request CPU 415 to decrypt and verify the data. For example, PIN data received from I/O device 505 may be encrypted, thus CPU 510 may request CPU 515 to decrypt the PIN data and to verify its authentication. The PIN data may be verified using data locally stored within module 210 or data stored in a local network that is readily accessible by module 210. In this way, PIN authentication can be performed locally without having to transmit the PIN data through conventional financial networks such as VisaNet in order to have the PIN authenticated. As previously mentioned, this affords retailers with the flexibility of issuing their own card. Since the intelligence required to authenticate a token card and a PIN is built into module 210, retailers may add additional functionalities to their own issued card without the need to obtain approval from issuing banks. For example, a retailer may chose to embed an RFID circuit onto card in order to execute a loyalty program that would award customers based on their shopping history.

In any case, CPU 515 may decrypt and encrypt data using keys stored within the memory cache of CPU 515 or keys stored in an external memory 525 in one embodiment, the keys are stored within the memory cache of CPU 515. In one embodiment, CPU 515 may also use a unique identification number associated with module 210, POS 104, or with the retailer that is hosting module 210 to encrypt the transactional data. In this way, the encrypted transactional data is unique to module 210, POS 104, or to the retailer.

Encrypting the transactional data with a unique POS 104 or retailer identification number offers several benefits. One of the benefits is the ability to uniquely associate security module 210 with a particular POS 104 or a retailer. Since every transactional data can be encrypted with a unique POS or retailer identifier, the paying bank can be instructed to only pay to the retailer that is associated the POS or retailer ID encrypted within the transactional data. Thus, even when module 210 is stolen and used somewhere else, the final payment can still go to the authorized owner of module 210. Another benefit is the real time detection of unauthorized devices such as a I/O device 505 that has been hacked. In module 210, the original authorized I/O device 505 can be configured to encrypt the pin and token data using a unique serial number or retailer ID number that is known to CPU 515. Thus, when CPU 515 decrypts PIN and token data received from I/O device 505, it can verify to see if the serial number or the retailer ID number matches with a stored serial or retail ID number. In the scenario, where there is a mismatch CPU 515 may execute a disable command or cause CPU 510 to perform other preventive security functions such as notifying someone of the fraud.

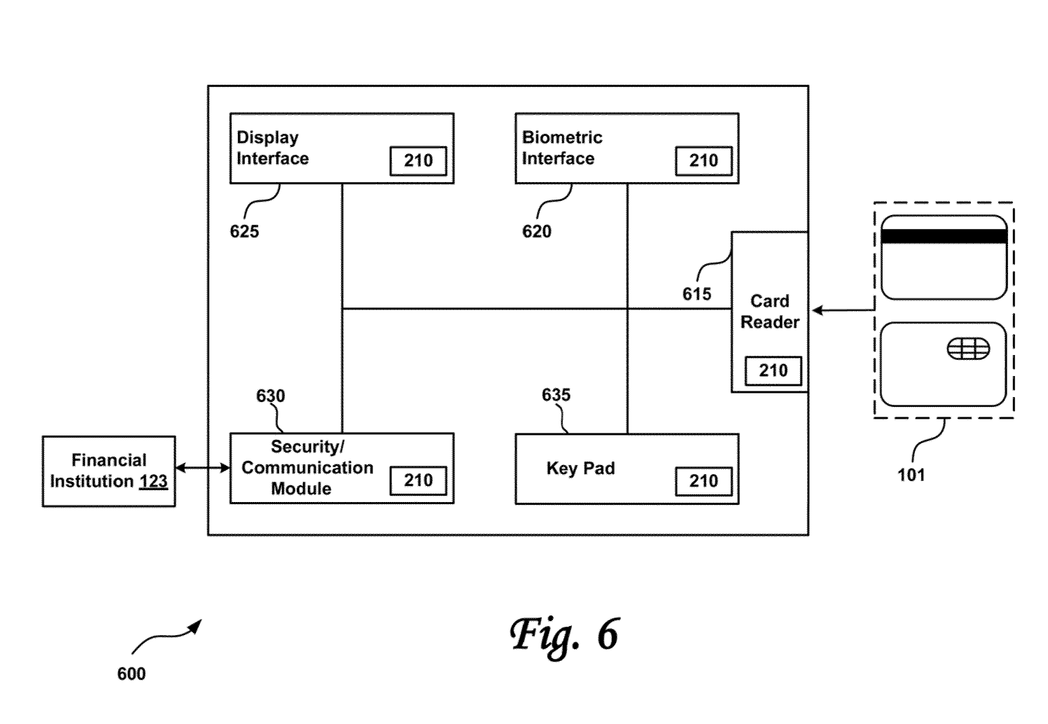

FIG. 6 illustrates a distributed security module 600 according to one embodiment of the present invention. Referring now to FIG. 6, in the illustrated embodiment, distributed security module 600 includes a card scanner module 6.15, a biometric module 620, a user interface module 625, a secure communication module 630, a key pad module 635, and a communication channel 640. As shown, each of the modules within module 600 includes its own security module 210 as previously described in each of the networks 200-400. All components of module 600 are also within a secured housing such as, for example, an epoxy encased steel housing. This distributed security architecture can prevent a hacker from hacking into any one of the modules and using the hacked module to gain access to other modules.

With a secure communication link between the financial institution to the POS security modules. POS key management and other control functions can be initiated by the financial institution. Either symmetric or public key exchange protocols can be used between the financial institutions and the security modules in the POS terminal to set initial or new keys along with configuring the various terminal options. The secure link between the financial institution 123 and the security/communication module 210 can either be a dedicated channel outside of the normal POS transaction network or can be implemented using the transaction network communication channels. For example, the latter can be accomplished by using data formatted as if it were normal card transaction data expected by the communication network elements.

To increase the security of the POS terminal module 600, the multiple security modules located within the module 210 can share components of the keys and other sensitive information. In this way to extract a key from module 600 requires successfully attacking multiple security modules. Each of the module components 210 can also periodically transmit encrypted status messages to each other and if a module ceases to reply to an interrogation, the other modules respond to an attack by erasing all sensitive information in the POS terminal module 600.

In module 600, biometric module 620 can be a fingerprint scanner or other biometric scanning device. User interface module 625 can be a monitor, a touch screen monitor, or other type of display device. Secure communication module 630 can be a communication interface used to externally transmit and receive data. Key pad module 635 can be a keyboard or a numeric key pad used to enter PIN or other personal identification information, such as a zipcode or a telephone number. Each of security module 210 within each of the modules 615-635 can be configured to encrypt outgoing data (data to be transmitted over communication channel 640) with a unique retailer ID number or a serial number of module 600. Alternatively, the serial number of the module where security module 210 resides can also be used. In this way, when data is received by anyone of the modules 615-635, the module receiving the data can decrypt the encrypted data to verify and determine whether a proper encryption has been performed (encrypted with a proper unique key). If the data is encrypted with the wrong retailer key or identification number, then the module that transmit the incorrect encrypted data may have been tampered with. In this case, module 600 may report the error to the retailer or may disable itself.

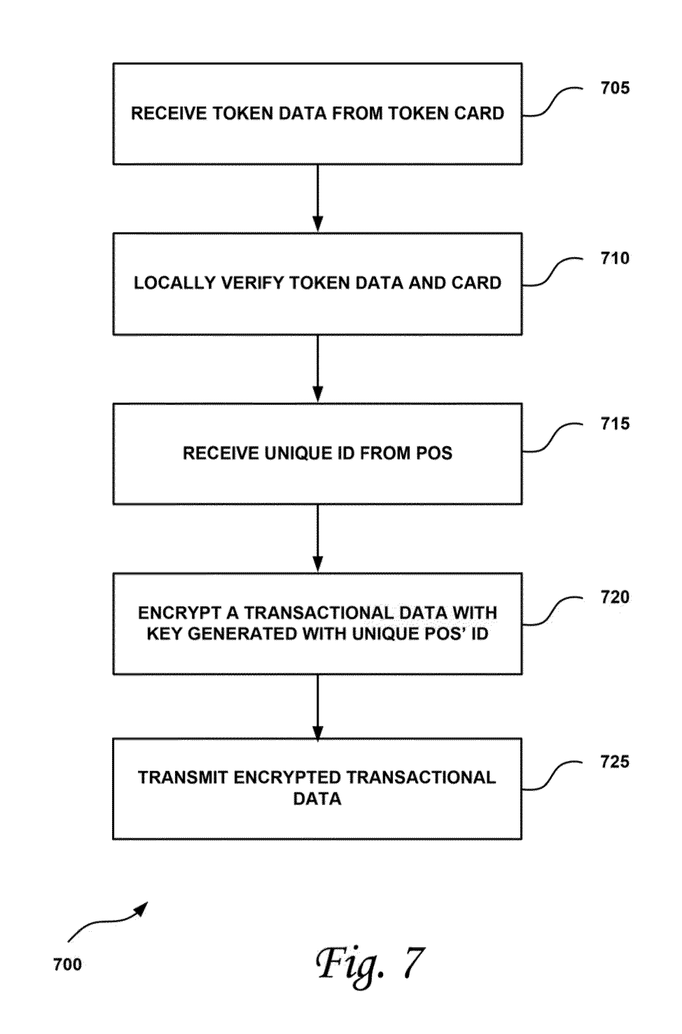

FIG. 7 illustrates an exemplary process flow 700 that can be implemented by security module 210 according, to one embodiment of the present invention. Process flow 700 starts at step 705 where token data is received from a local terminal such as data capture device 103 of network 200. In one embodiment, a PIN data can also be collected at step 705. In step 710, the token data and the PIN data can be locally authenticated using security module 210. As mentioned, security module 210 may perform token and PEN data authentication using locally stored authentication data. The authentication data may be stored in a re-mote server upstream of gateway 120 or on a network that can be immediately accessible by smart security module 210. Alternatively, the authentication data can be stored within security module 210.

Local authentication offers several benefits. For example, authentication can be done immediately at the front edge of the network, thus reducing or eliminating the potential for fraud; and the retailer can execute loyalty, customer service, or data aggregation programs locally because the retailer now has control of the authentication and identification processes. In a conventional network, a retail cannot issue its own unique card, which is needed to execute loyalty or other programs, without first obtaining adoption from all of the issuing, banks. Local authentication allows a retailer to issue its own token card. The retailer issued card can still be a VISA, MasterCard, Discover, American Express or other card but with a PIN associated to the account number of the card. The PIN can be selected by the cardholder but is stored by the card issuing retailer instead of the issuing banks such as VISA or MasterCard. This allows security module 210 to perform local authentication of the token and pin data of the card.

In step 715, once the token and PIN data are authenticated, the transactional data is encrypted. In one embodiment, the transactional data is encrypted using CPU 515 (shown in FIG. 5) of module 210. Once the transaction data is encrypted, it is sent to financial institution such as institution 123.

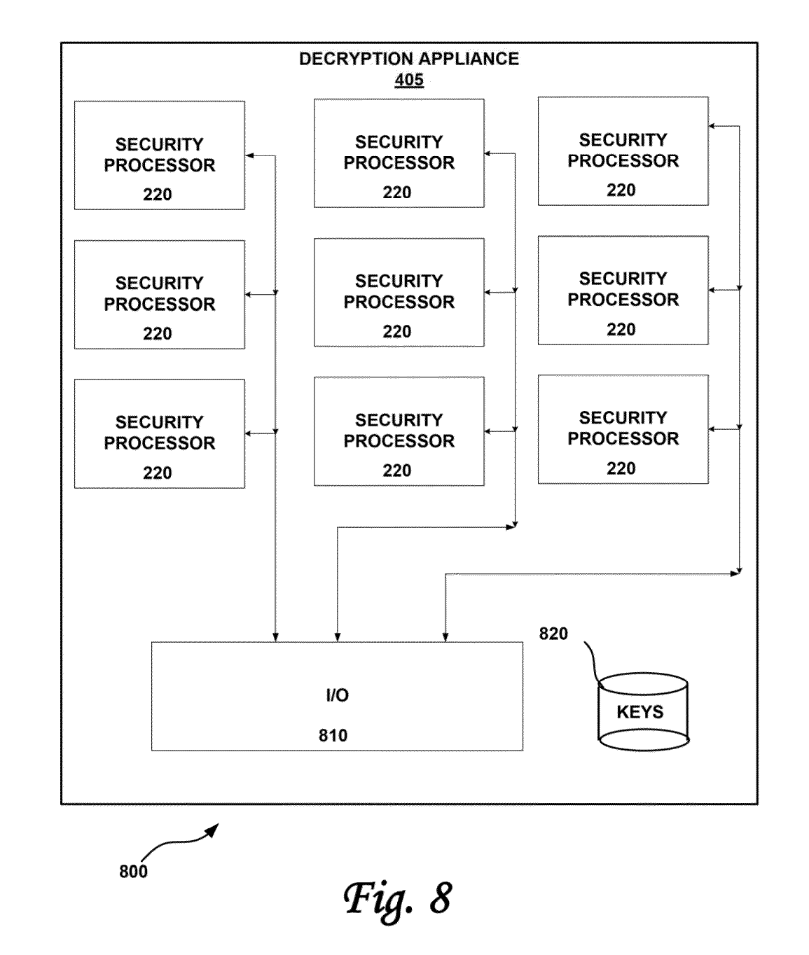

FIG. 8 Illustrates the use of multiple security processors 220 in the decryption appliance 405. Each security processor 220 uses in the magstripe reader or POS is capable of a symmetric key encryption operation every millisecond and a asymmetric encryption every second. While these very low cost and secure modules are far too slow to meet the 1000 decryptions per second needed for a decryption appliance 405 with a array of 1000 security modules 220 along with a key store 820 and I/O 810 each of the security modules can work in parallel to accomplish one thousand asymmetric encryption operations per second. Each security module 220 is a secure processing unit. Further, the POS encryption security module 220 is equivalent to each decryption security module 220 compatibility between encryption and decryption is guaranteed.

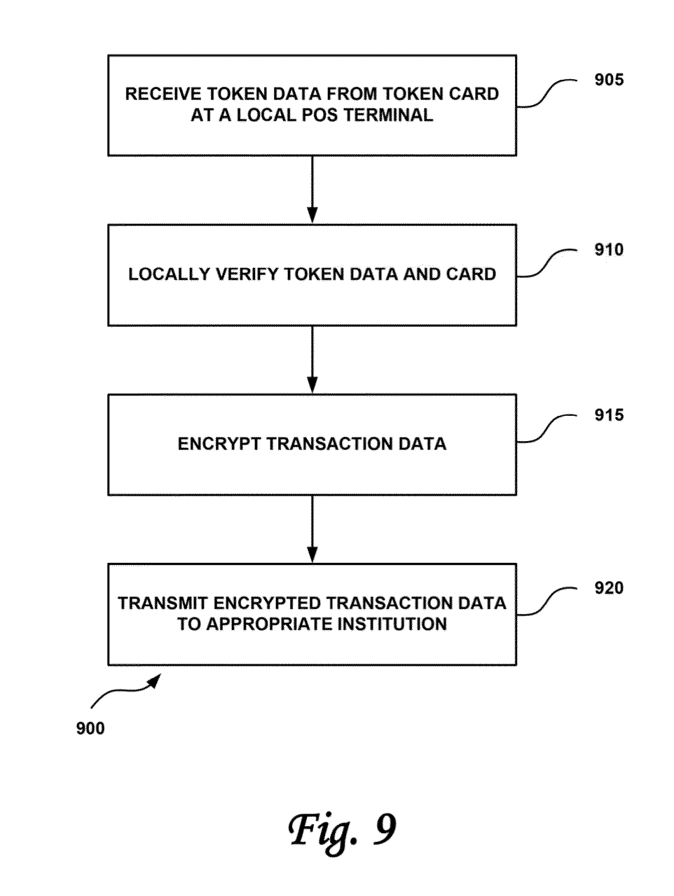

FIG. 9 illustrates a transaction process flow 900 according to one embodiment of the present invention. Example process 900 starts at step 905 where token data and PIN data are received. In step 910, the token and PIN data are locally authenticated using security module 210 similar to step 610. In one embodiment, verification at step 910 is done using warble or jitter. Alternatively, verification can be done by directly sending token and PIN data to the issuing bank, which then performs the card and PIN data authentication.

In step 915, a unique identification of the POS or the retailer is received. Alternatively, this step is optional because the unique identification of the POS or the retailer can be pre-programmed into security module 210 memory. In one embodiment, a unique identification of the HSM can be used in place of the POS. In step 920, the transactional data is encrypted with a key generated with the unique POS or retailer identification. In this way, the transactional data can have an encrypted code that is specific to a particular POS or retailer. In step 925, the encrypted transactional data is transmitted to bank or other financial institution.

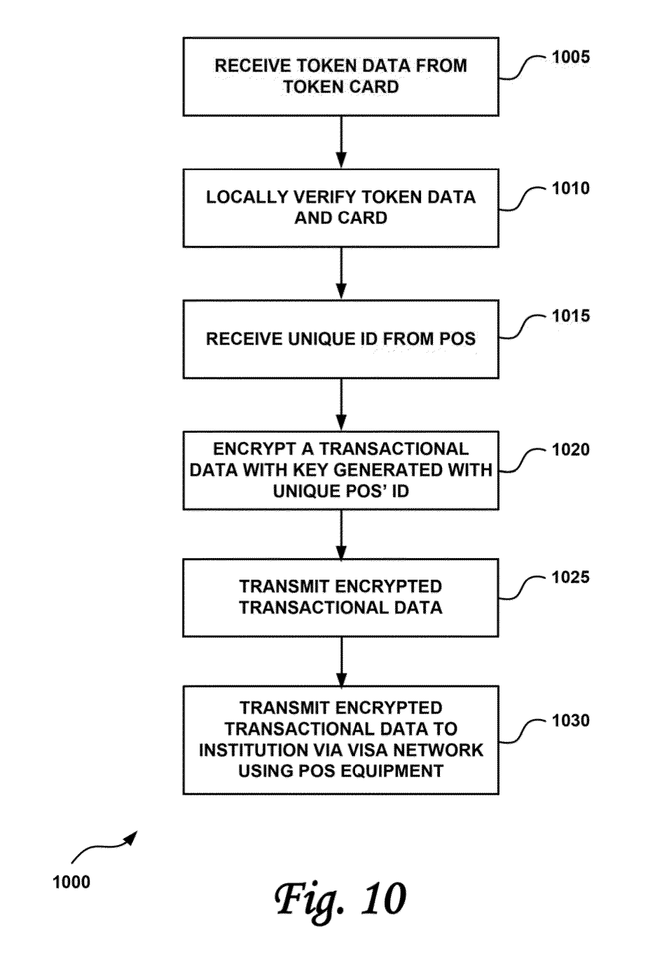

FIG. 10 illustrates a transactional process flow 1000 according to one embodiment of the present invention. Steps 1005-1020 of process flow 1000 are similar to steps 905-920 of process flow 900. In step 1025, encrypted transactional data is relayed back to the POS such as POS 104. In this way POS 104 may use either the retailer own financial network or use a conventional or legacy financial network (e.g. VisaNet, NOVA, and Discover Network) to complete the transaction. In step 1030, encrypted the transactional data is transmitted to a financial institution such as institution 123 via the retailer's own financial network or a conventional financial network such as VisaNet.

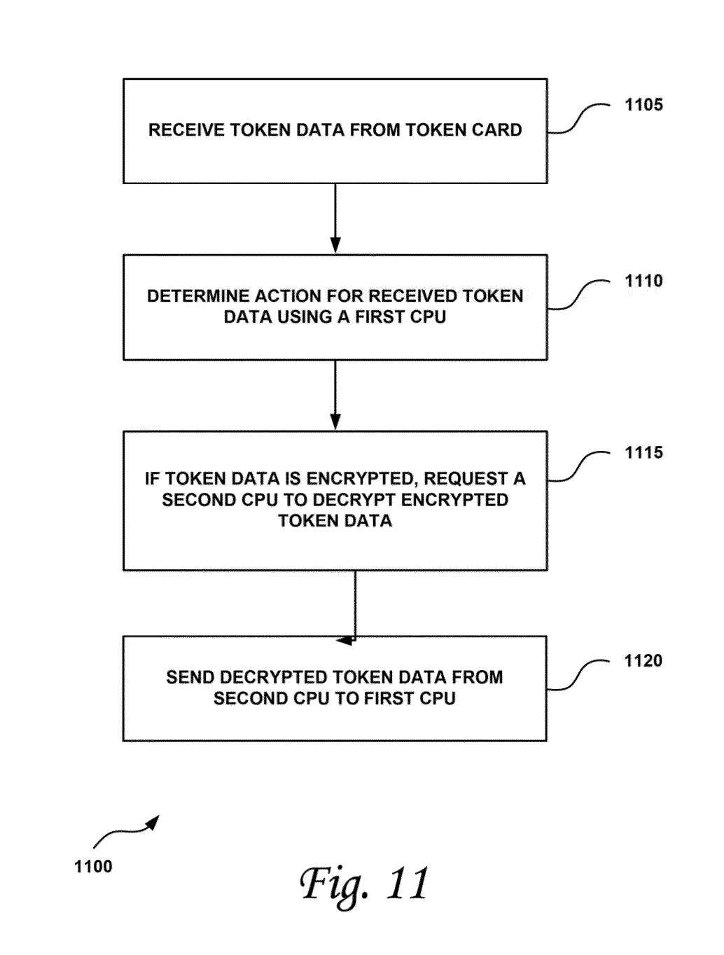

FIG. 11 illustrates a transactional process flow 1100 according, to one embodiment of the present invention. Process flow 1100 starts at step 905 where token data is received from a data capture device. In step 1110, a first CPU such as CPU 410 of security module 210 determines what to do with the received data based on whether the token data is encrypted or not. In step 1115, if the data is encrypted, the CPU 410 sends a request to a second CPU such as CPU 415 to decrypt the encrypted token data. Once the data is decrypted, CPU 415 sends the decrypted token data back to CPU 410. Process flow 1100 may also process pin data received from a terminal in similar ways.

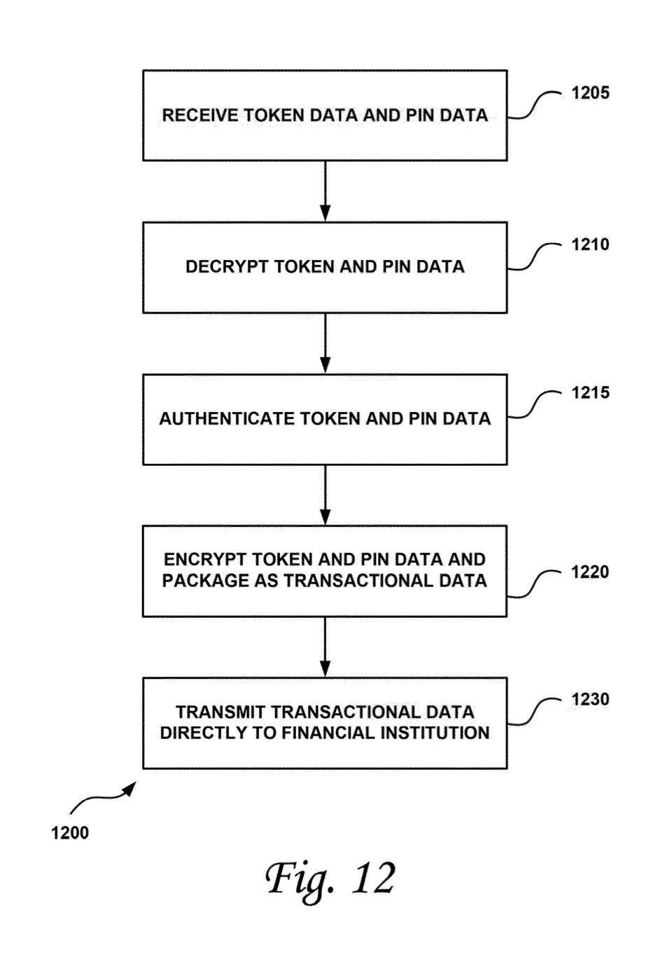

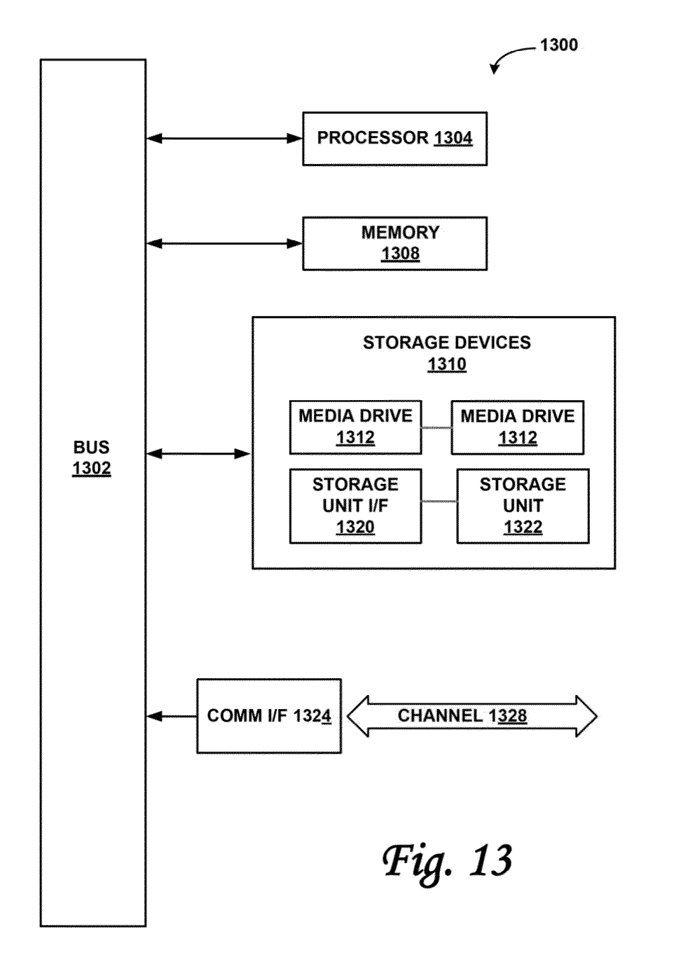

FIG. 12 illustrates a transactional process flow 1200 that can be implemented by module 210 or 500 according to one embodiment of the present invention. Referring now to FIG. 12, example process flow 1200 starts at step 1205 where the token and PIN data are received. In step 1210, if any of the token or PIN data is encrypted, that data is decrypted for authentication and other transactional purposes such as receipt printing using the last 4 digits of account number or printing the token holder's name on the receipt.

In step 1215, the token and PIN data are authenticated by a security module such as module 210. This authentication process may be done locally and without having to transmit the token and PIN data to an issuing bank or a remote decryption appliance for authentication. This way the retailer that owns the module 210 has control over the authentication process, thus allowing the retailer to execute its own customer service programs. Alternatively, the retailer can configure module 210 to communicate directly with the issuing bank for authentication and authorization. In step 1220, the token and PIN data is encrypted and packaged with other data such as purchase price, date, store H), etc. to create a transactional data. This transactional data is then sent directly to a financial institution for final settlement in step 1230, hi this way, retailers and banks have the option of issuing a card that does not have to use the traditional financial network such as VisaNet or Discover Network for authentication and settlement.

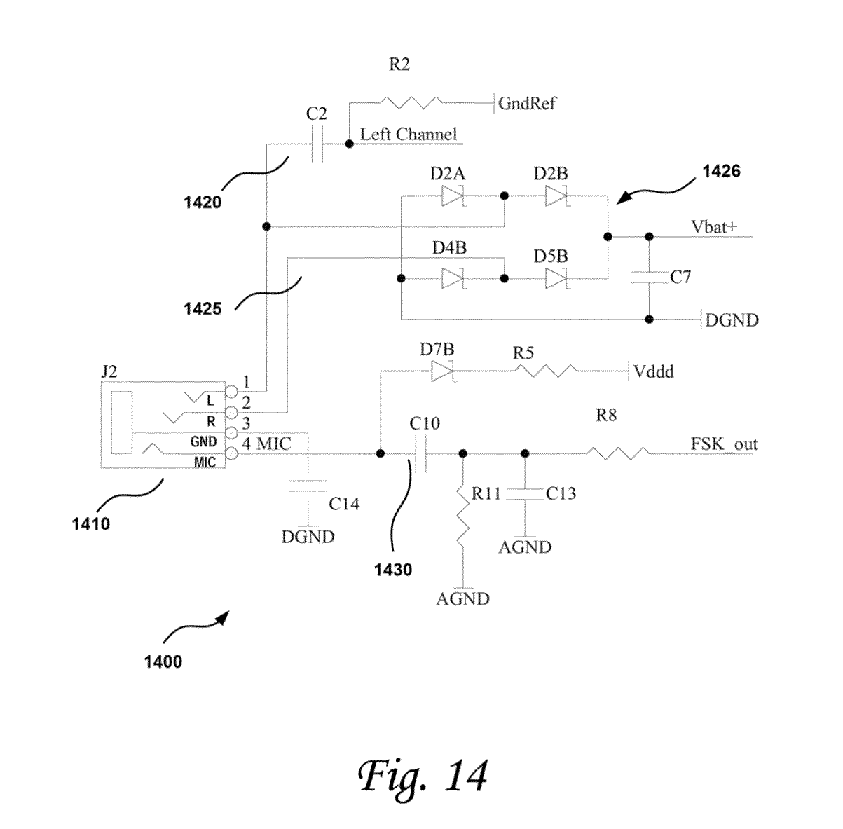

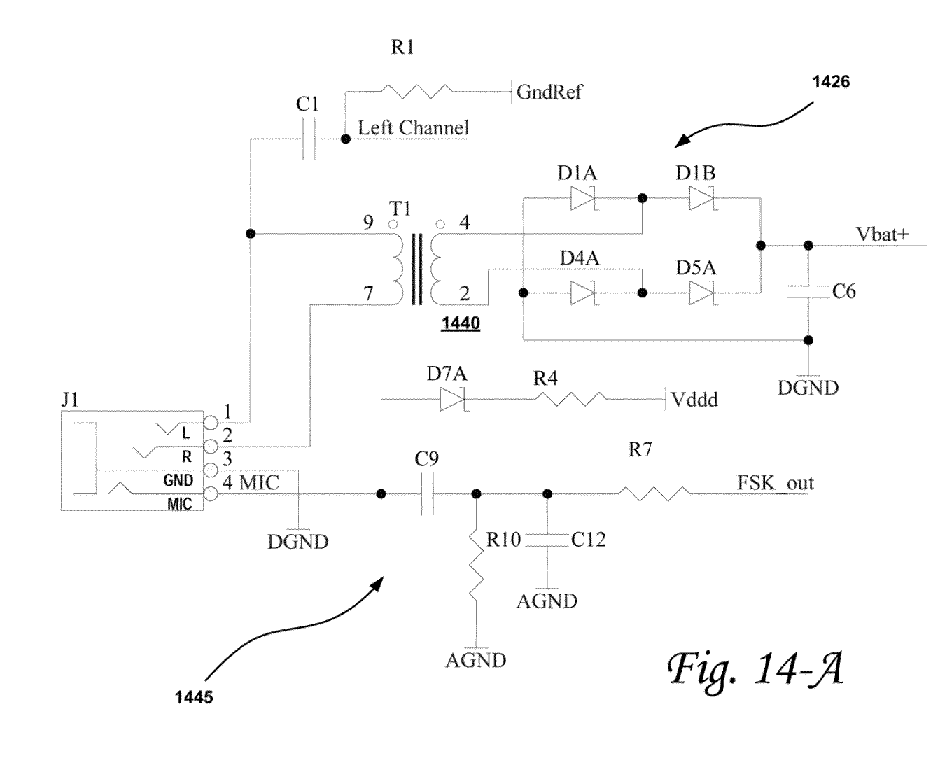

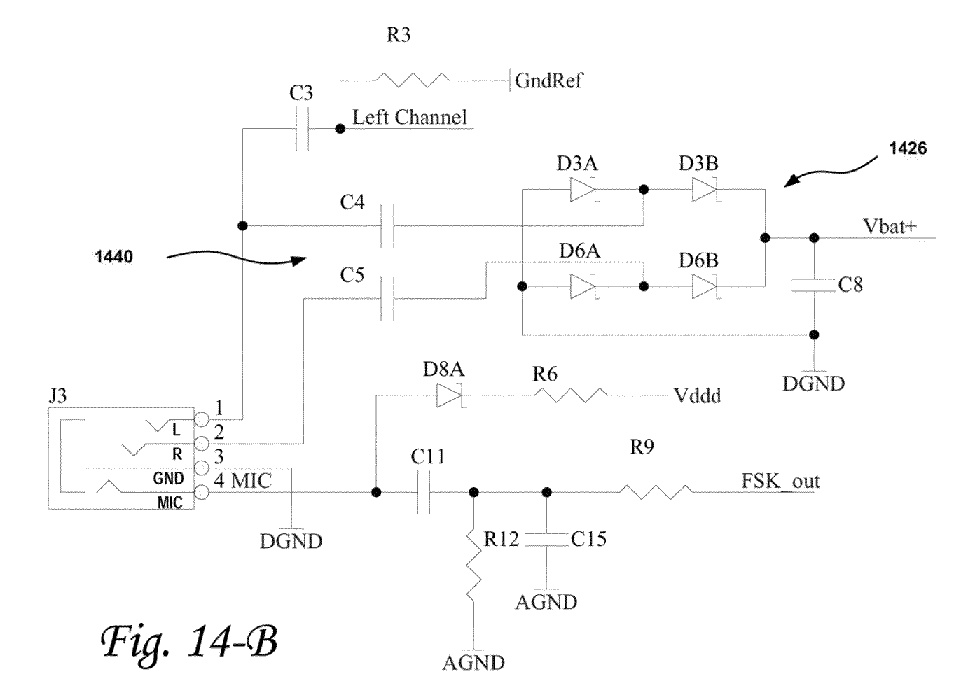

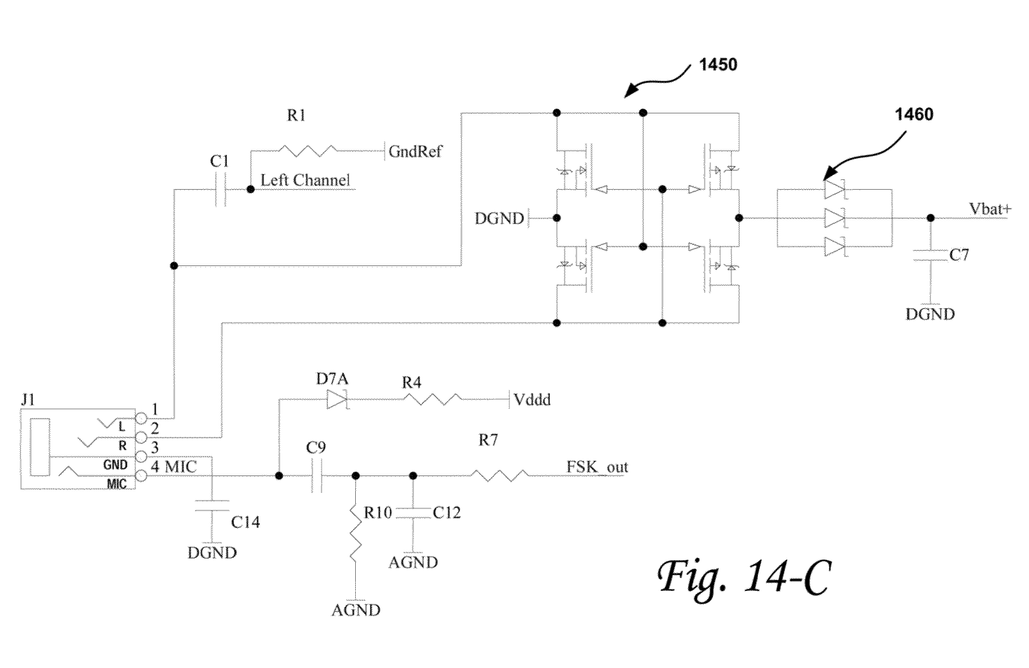

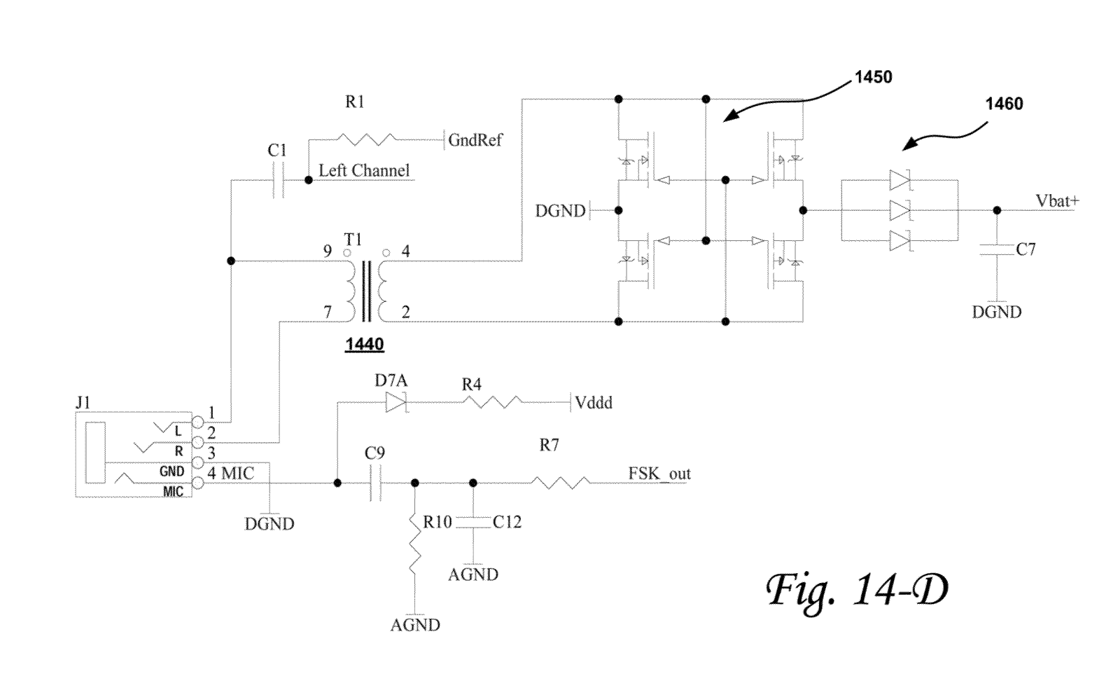

FIG. 14 is a diagram illustrating an implementation audio jack interface for attachments to mobile phones, tablets and PDAs. The audio jack 1410 interfaces to the POS device through a left and right output channel 1420, 1425 and a microphone input channel 1430. The POS application output to the left channel 1420 a square wave audio signal and to the right channel 1425 a square wave 180 degrees out of phase with the left channel. The left and right channels 1420, 1425 are full wave rectified 1426 1425 to supply operating power for the token reader 103. Command data is send from the POS device to the token reader by modulating the output square wave output signal. The token reader 103 outputs the token data to the POS as an audio signal output on the microphone input 1430.

FIG. 14-A is a diagram illustrating an implementation audio jack interlace for attachments to mobile phones, tablets and PDAs where the audio output is transformer isolated 1440 allowing the POS ground connection to be DC coupled 1445 to the token reader 103.

FIG. 14-B is a diagram illustrating, an implementation audio jack interface for attachments to mobile phones, tablets and PDAs where the audio output is capacitor isolated 1440 allowing the POS ground connection to be DC coupled 1445 to the token reader 103.

FIG. 14-C is a diagram illustrating an implementation audio jack interface for attachments to mobile phones, tablets and PDAs where the audio output conversion efficiency is improved by combining embodiments from FIGS. 14, 14A, and 14B.

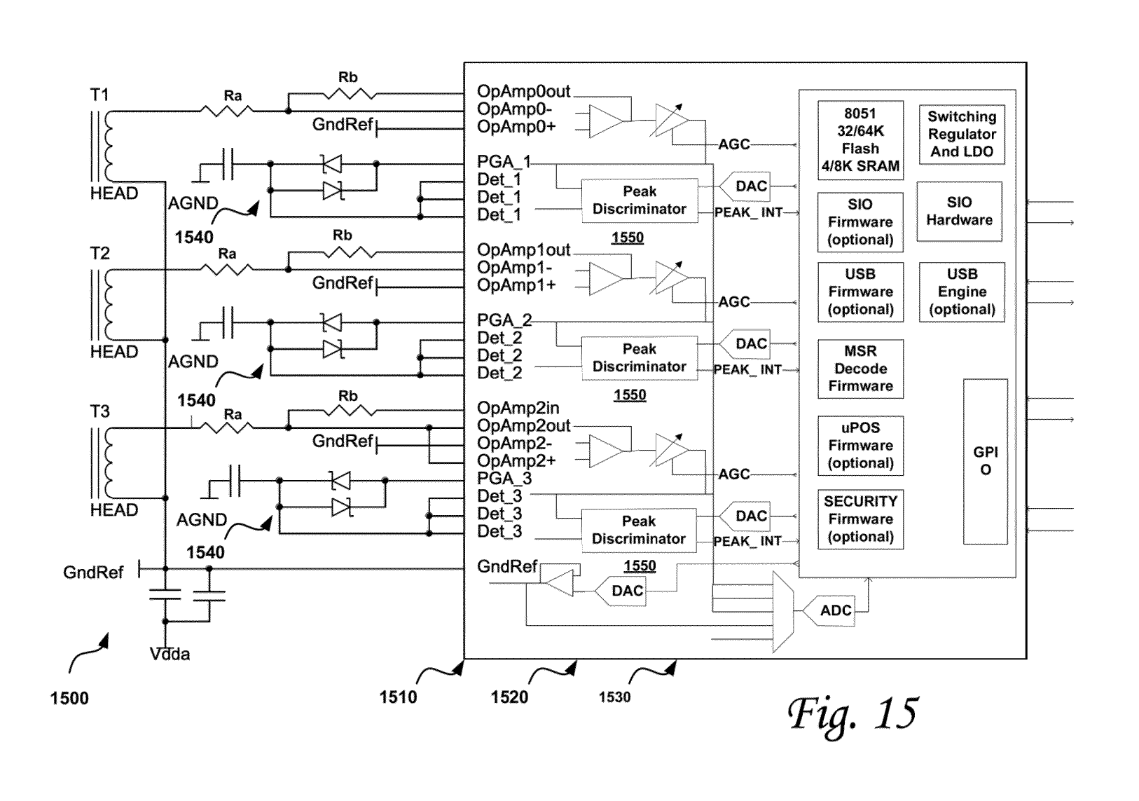

FIG. 15 is a block diagram illustrating an implementation of the COTS single chip peak detector according to one embodiment of the present invention. In accordance with one embodiment of this invention a COTS Cypress PSoC® processor 1510 with programmable analog 1520 and digital arrays 1530 is used in conjunction with a novel peak detect circuit 1540, uses a diodes property of forward voltage drop to delay the signal being detected from charging a capacitor by a small amount. The output of the delayed, signal and the non-delayed signal are compared to each other. The delayed signal follows the non-delay signal by the forward voltage drop. During a peak transition the delay signal crosses the non-delay signal. The peaks caused by magnetic flux transitions have steep slopes the transition occurs with a fixed and predictable delay from the actual peak. Further the peak to transition delay is very constant the transition caused by one peak and the following peak represents the peak to peak transition time. The window detection function on the PSoC used in conjunction with this peak detector prevents false peak triggers when the input signal is close to ground between peak detections or when there is no transition data present. The increased performance of this circuit in measuring the location of peaks over other peak detectors allows for the implementation of the Warble® card data authentication system with no added cost.

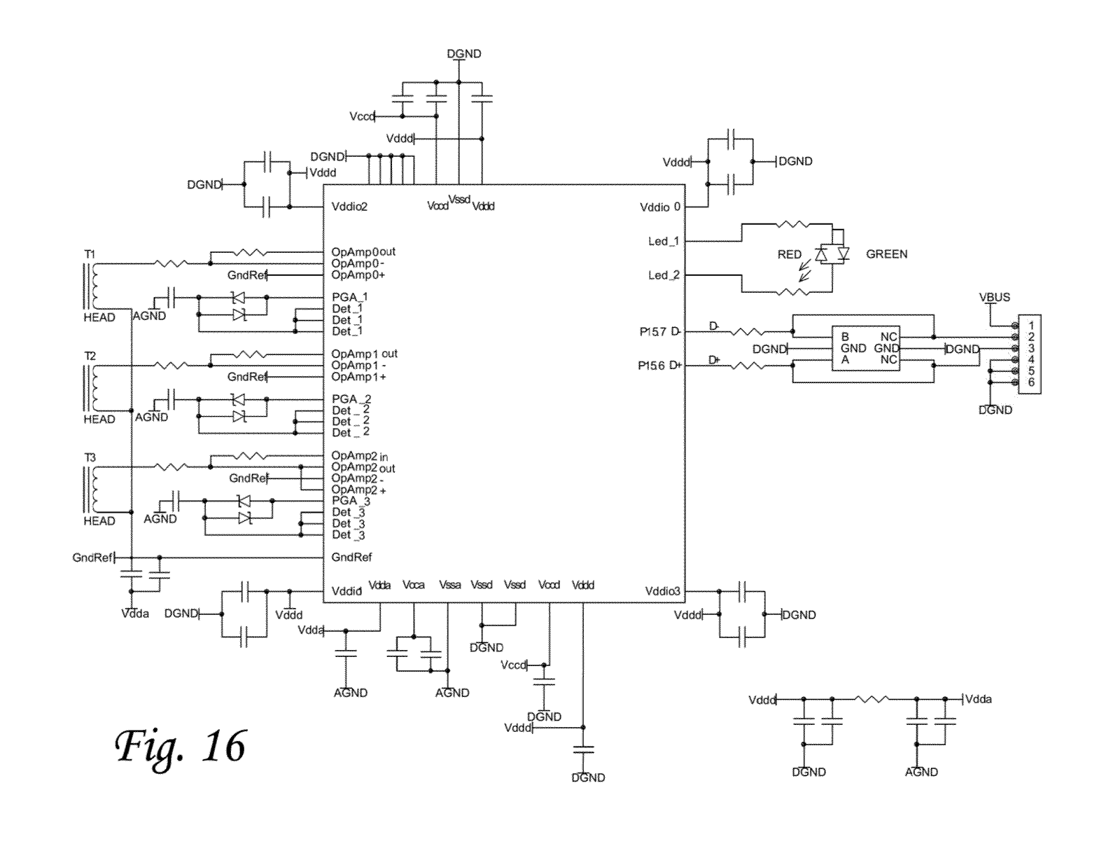

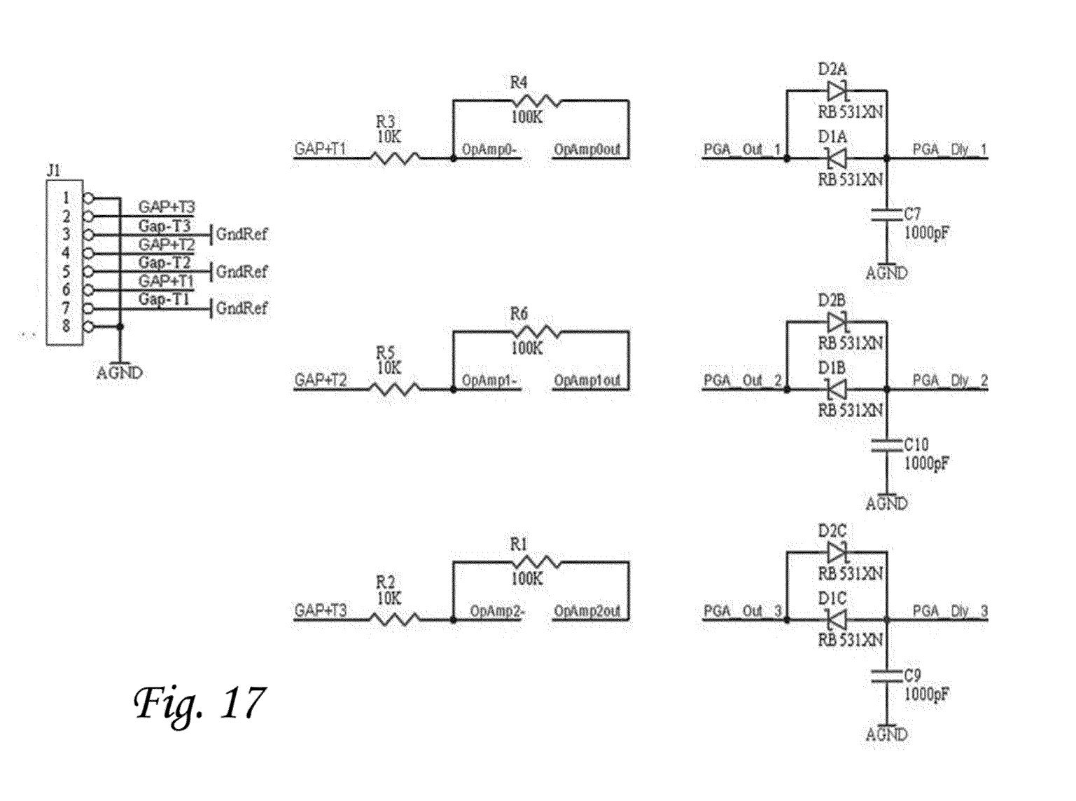

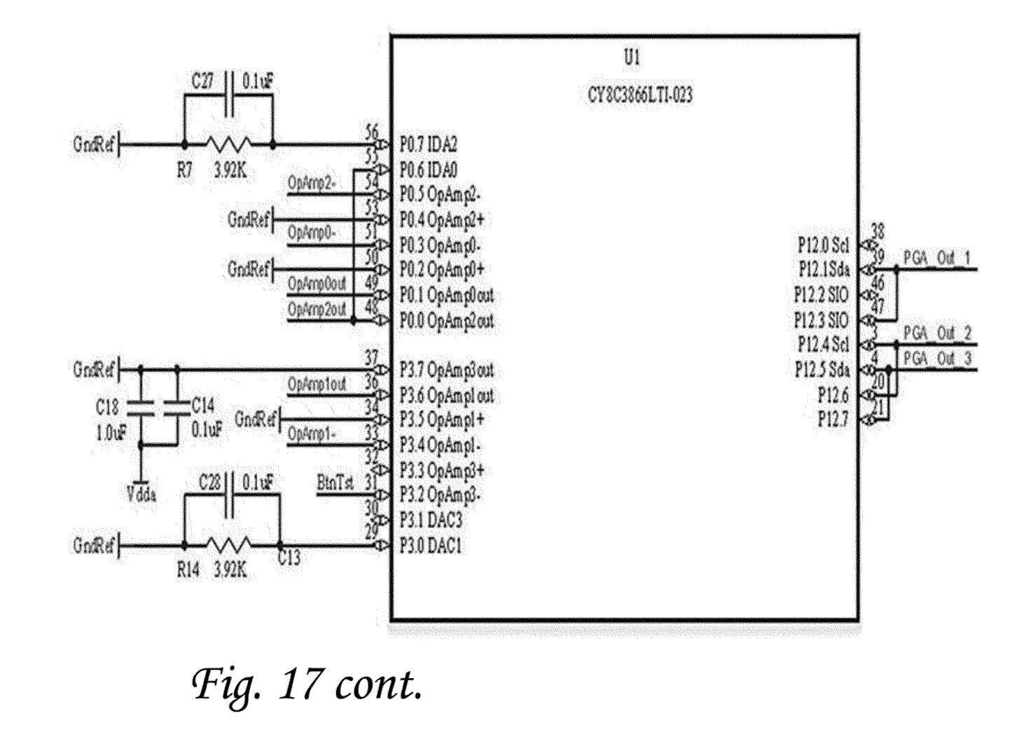

FIGS. 16 and 17 is a schematic diagram illustrating an implementation of the complete USB magstripe token reader using a COTS single chip controller.

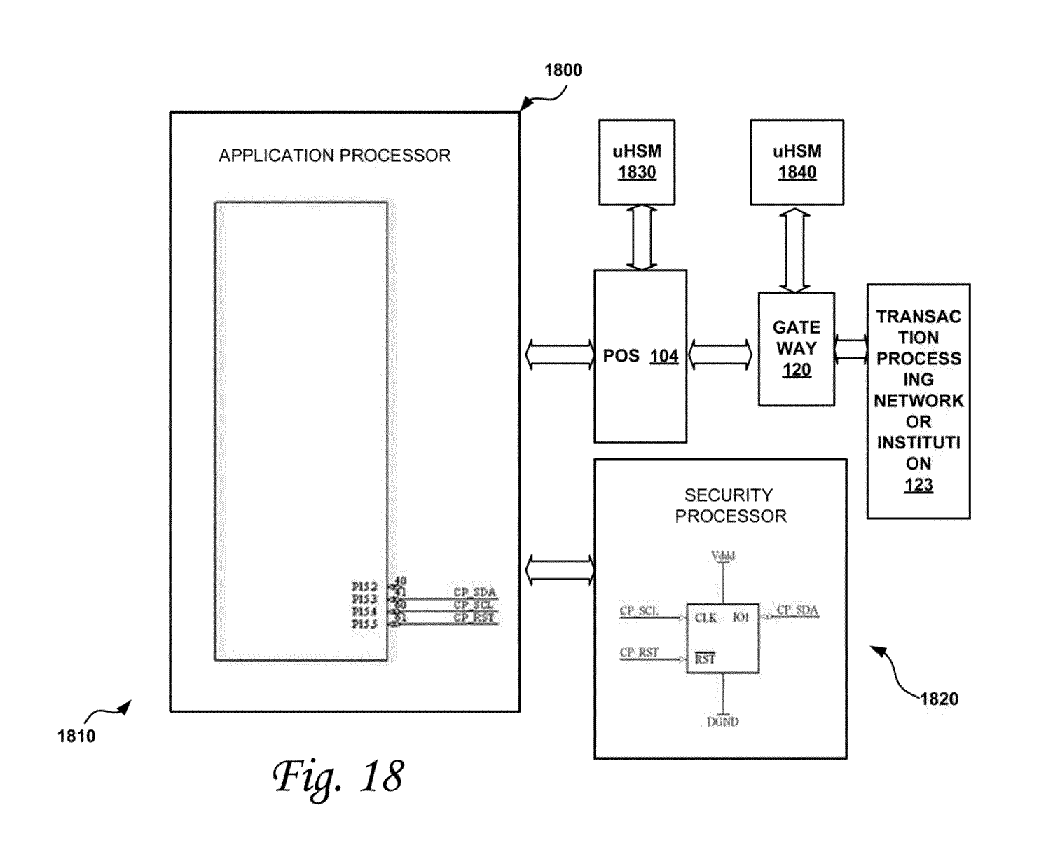

FIG. 18 is a diagram of one embodiment of this invention where the data capture device 103 consists of a separate application processor 1810 and security processor 1820. The application processor consisting 1810 of a (TOTS single chip processor and the security processor 1820 consists of a COTS smart card chip with secure transaction processing functions built in. The transaction processing network 123 keys are maintained in the security processor 1820. In one embodiment, token data is encrypted with a one DUKPT key shared between the application processor 1810 and the security processor 1820. The security processor 1820 decrypts the token data and re-encrypts it in a compatible format with the POS 104, Gateway 120 and processing network 123. In another embodiment the data re-encrypted by the security processor 1820 is decrypted by the POS 104 or the gateway 120 using the uHSM 1830 or 1840.

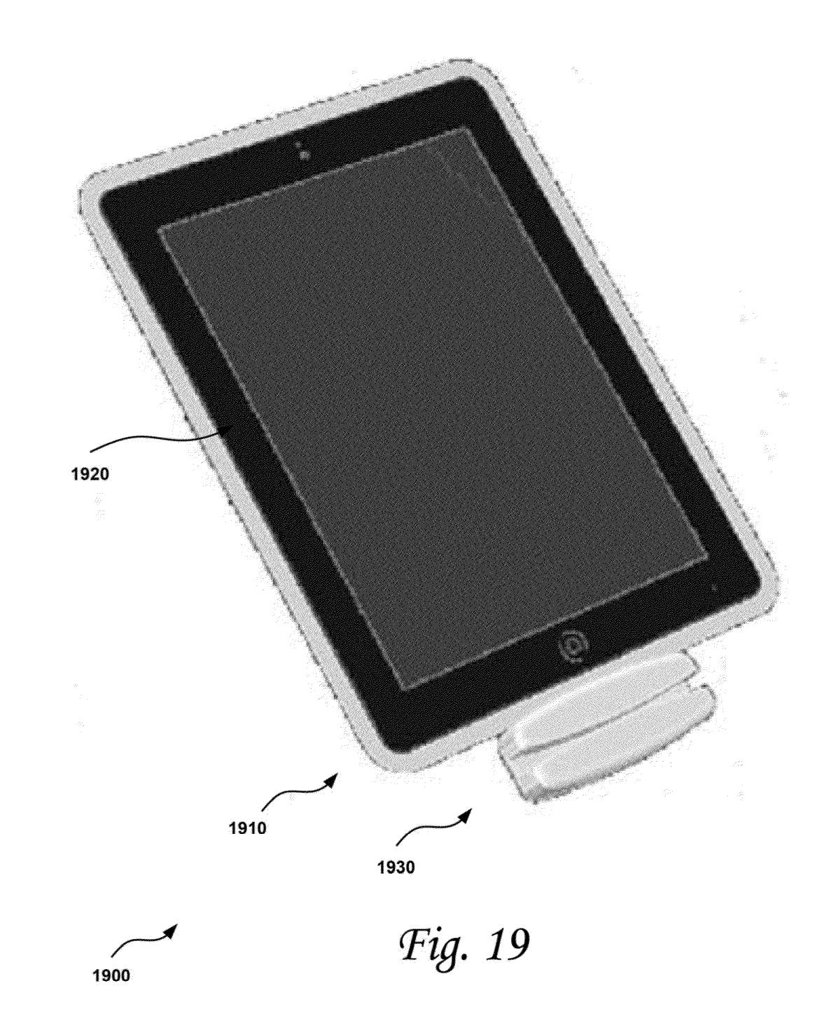

FIG. 19 illustrates the use of a token reading accessory 1910 for as POS device 1920 providing encrypted card data via the token reader 1930 to the POS tablet device 1920.

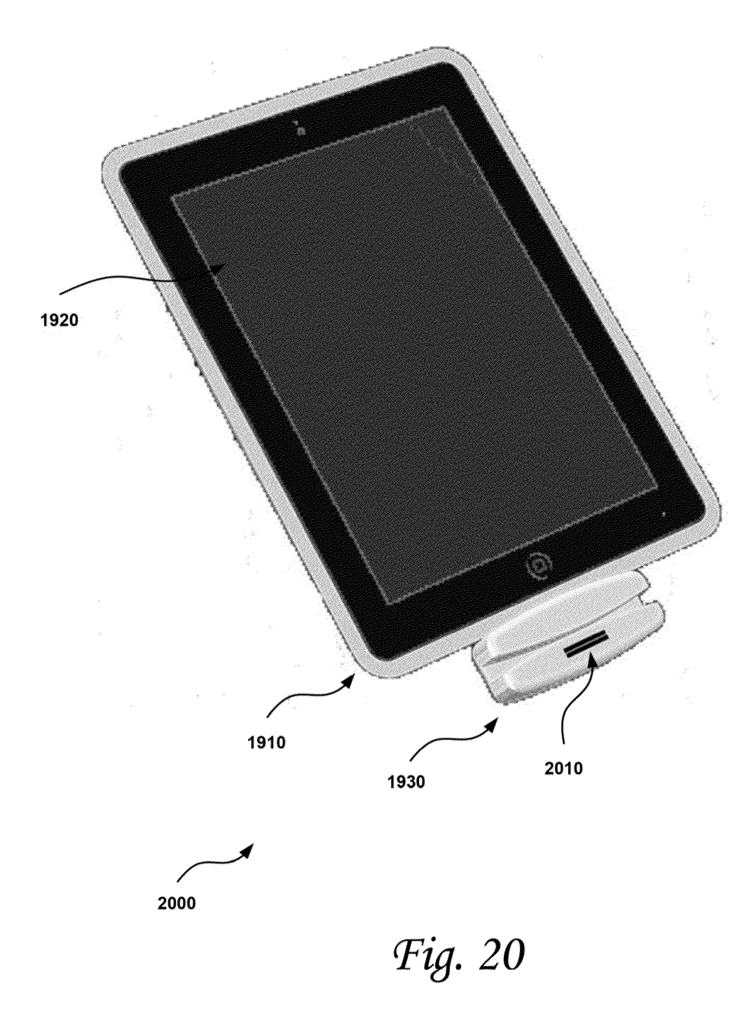

FIG. 20 illustrates the use of a token reading accessory 1910 for a POS device 1920 providing encrypted card data via the token reader 1930 to the POS tablet device 1920 where the identity of the POS user is verified using biometric reader 2010.

In one embodiment the biometric reader 2010 is used by the customer in place of another token such as a credit card.

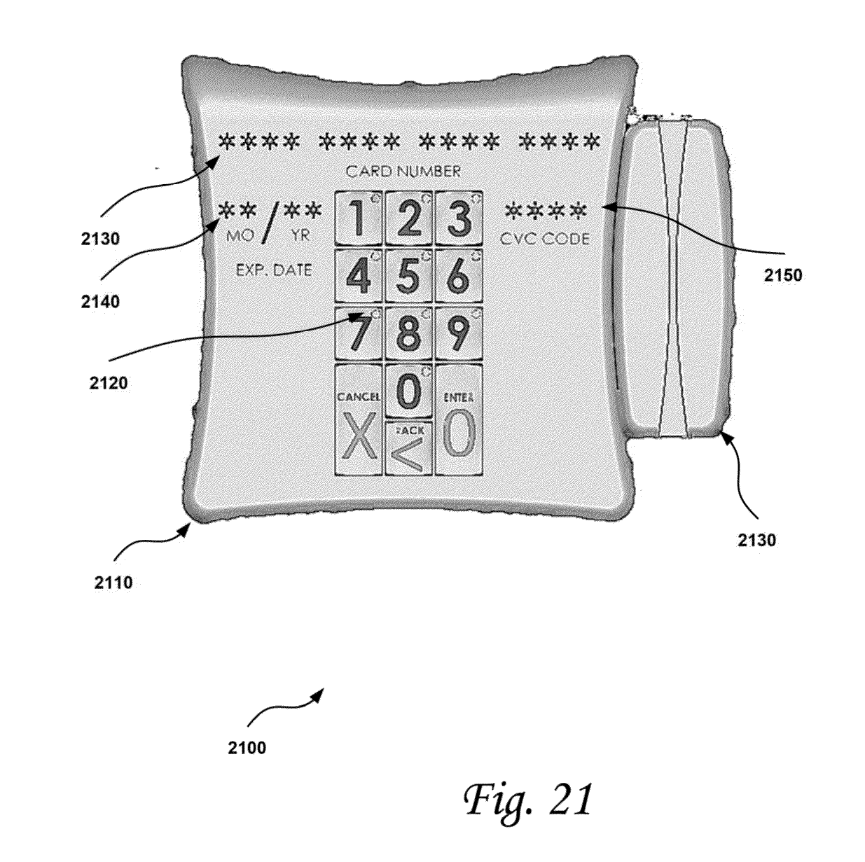

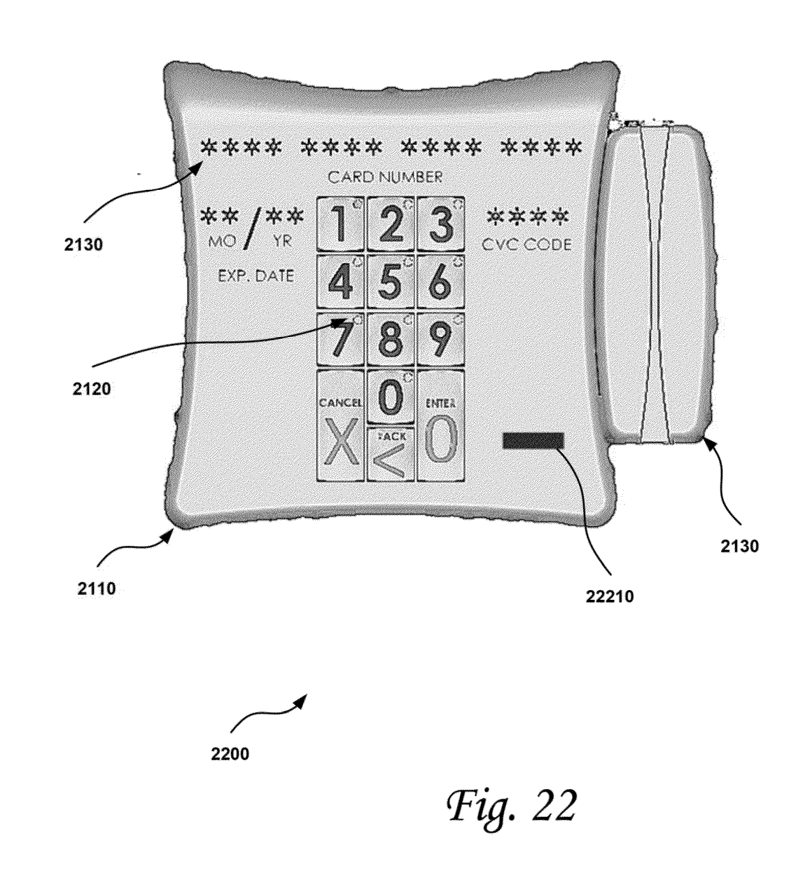

FIG. 21 illustrates the use of a token reading accessory with keypad and display 2110 for a POS. For swiped token and used identity entry the magstripe reader 2130 is used. For manual data entry credit and debit information when a key is pressed a LED 2120 lights to indicate the key pressed. In addition the position of the next PAN digit to be entered is indicated by LED row 2130. When the entry of the PAN is complete the expiry date led digit in the expiry date row lights to indicate the next digit to enter. After the expiry date 2140 entry is complete the CVC code 2150 is requested. As each key is pressed the key LED 2102 lights until the next key is pressed where the first key LED is extinguished and the new key LED lights. FIG. 22 illustrates the token reader and keyboard of 1900 with the addition if biometric, reader 2210 for authenticating the POS device user.

FIG. 22 illustrates the use of a token reading accessory with biometric reader, keypad and display 2110 for a POS. POS user identity is verified using biometric input 2210. In addition biometric input 2210 is also used to verify the customers identity for authorizing a transaction.

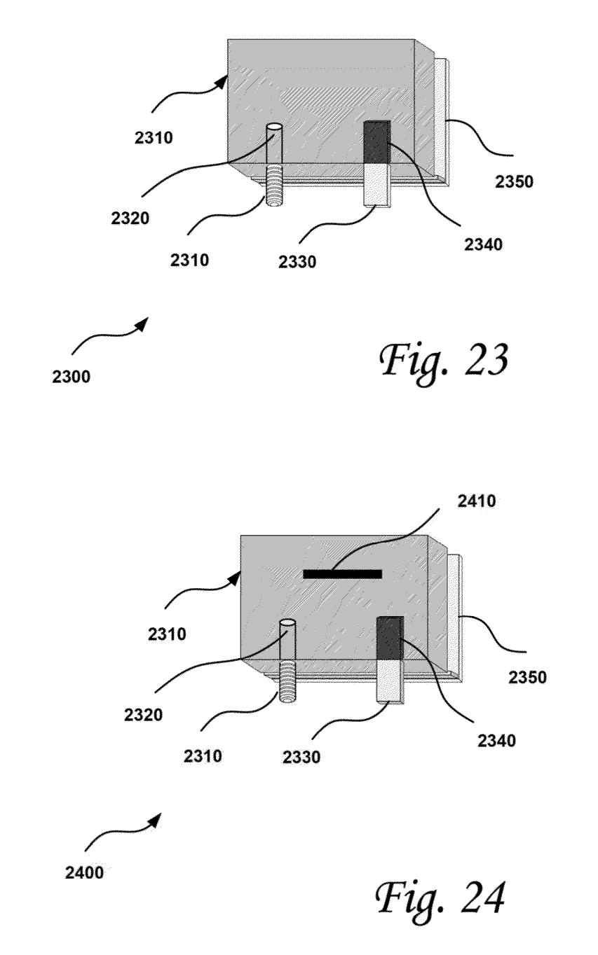

FIG. 23 illustrates a token reader 2310 with a card magnetic stripe token reader 2350 for input token data using one of two communication interfaces. For mobile devices where a headphone jack reader is required, the phone plug 2310 is inserted into the mobile device and the USB communication channel 2330 is retracted into cavity 2340. For devices requiring an USB communication channel, the headphone jack connector 2310, is retracted into cavity 2320 and the USB communication interface 2330 is inserted into the POS platform. For storage both communication interface connectors 2310, 2330 are retracted into their respective cavities 2330, 2340.

FIG. 24 illustrates a token reader 2310 of FIG. 23 with a secondary biometric token reader 2410, in one embodiment, the biometric token reader 2410 is used to verify the identity of the POS user to prevent unauthorized transaction. In another embodiment, the biometric token reader 2310 is used to verify the customers identity to prevent unauthorized transaction. In another embodiment the biometric token reader 2310 is used to identify the customer providing for secure transactions without magstripe data.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety, if a definition set forth in this section is contrary to or otherwise inconsistent with a definition set forth in applications, published applications and other publications that are herein incorporated by reference, the definition set forth in this section prevails over the definition that is incorporated herein by reference.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing, module capable of carrying out the functionality described with respect thereto. One such example computing module is shown in FIG. 11. Various embodiments are described in terms of this example-computing module 1100. After reading this description, it will become apparent to a person skilled in the relevant art how to implement the invention using other computing modules or architectures.

Referring now to FIG. 11, computing module 1100 may represent, for example, computing or processing capabilities found within desktop, laptop and notebook computers; hand-held computing devices (PDA's, smart phones, cell phones, palmtops, etc.); mainframes, supercomputers, workstations or servers., or any other type of special-purpose or general-purpose computing devices as may be desirable or appropriate for a given application or environment. Computing module 1100 might also represent computing capabilities embedded within or otherwise available to a given device. For example, a computing module might be found in other electronic devices such as, for example, digital cameras, navigation systems, cellular telephones, portable computing devices, modems, routers, WAPs, and other electronic devices that might include some form of processing capability.

Computing module 1100 might include, for example, one or more processors or processing devices, such as a processor 1104. Processor 1104 might be implemented using a general-purpose or special-purpose processing engine such as, for example, a microprocessor, controller, or other control logic. In the example illustrated in FIG. 11, processor 1104 is connected to a bus 1102 or other communication medium to facilitate interaction with other components of computing module 1100.

Computing module 1100 might also include one or more memory modules, referred to as main memory 1108. For example, preferably random access memory (RAM) or other dynamic memory, might be used for storing information and instructions to be executed by processor 1104. Main memory 1108 might also be used for storing temporary variables or other intermediate information during, execution of instructions to be executed by processor 1104. Computing module 1100 might likewise include a read only memory (“ROM”) or other static storage device coupled to bus 1102 for storing static information and instructions for processor 1104.

The computing module 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a floppy disk drive, a magnetic tape drive, an optical disk drive, a CD or DVD drive (R or RW), or other removable or fixed media drive. Accordingly, storage media 1114, might include, for example, a hard disk, a floppy disk, magnetic tape, cartridge, optical disk, a CD or DVD, or other fixed or removable medium that is read by, written to or accessed by media drive 1112. As these examples illustrate, the storage media 1114 can include a computer usable storage medium having stored therein particular computer software or data.

In alternative embodiments, information storage mechanism 1110 might include other similar instrumentalities for allowing computer programs or other instructions or data to be loaded into computing module 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory module) and memory slot, a PCMCIA slot and card, and other fixed or removable storage units 1122 and interfaces 1120 that allow software and data to be transferred from the storage unit 1177 to computing module 1100.

Computing module 1100 might also include a communications interface 1124. Communications interface 1124 might be used to allow software and data to be transferred between computing module 1100 and external devices. Examples of communications interface 1124 might include a modem or softmodem, a network interface (such as an Ethernet, network interface card, WiMedia, 802.XX or other interface), a communications port (such as for example, a USB port, IR port, RS232 port Bluetooth interface, or other port), or other communications interface. Software and data transferred via communications interface 1124 might typically be carried on signals, which can be electronic, electromagnetic, optical or other signals capable of being exchanged by a given communications interface 1124. These signals might be provided to communications interface 1124 via a channel 1128. This channel 1128 might carry signals and might be implemented using a wired or wireless medium. Some examples of a channel might include a phone line, a cellular link, an RE link, an optical link, a network interface, a local or wide area network, and other wired or wireless communications channels.

In this document, the terms “computer program medium” and “computer usable medium” are used to generally refer to media such as, for example, memory 1108, storage unit 1120, media 1114, and signals on channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1100 to perform features or functions of the present invention as discussed herein.

While various embodiments of the present invention have been described above, it should be understood that the have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations, indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening; words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading, this document, the illustrated embodiments and their various alternatives can be implemented without confinement to the illustrated examples. For example, block diagrams and their accompanying description should not be construed as mandating a particular architecture or configuration.

1. A method for processing token based financial transactions, comprising:
receiving a token information;
performing a non-security task on the token information using a first processor, wherein the non-security task includes one or more tasks from the group of encryption determination, encryption-decryption request, key management, token information delivery, or transactional data delivery;
sending a job request to the second processor through a defined interface using the first processor; and
performing a security-related task based on the on the token information using a second processor based on the job request from the first microprocessor, wherein the security-related task includes one or more tasks from the group of token information authentication, token information decryption, or token information encryption, wherein, the second processor is configured to only accept the job request if it is for one of the security-related tasks.

2. The method of claim 1, wherein both of the first and second processors are contained within the same security housing.

3. The method of claim 1, wherein the second processor is a security processor based on a smart card enabled processor.

4. The method of claim 1, wherein the first and second processors are permanently linked and then the linking capabilities are disabled once the processors are successfully linked preventing and further modification of the linked connection.

5. The method of claim 4, wherein the permanent link is accomplished at the first power-up cycle of the application processor and the security processor.

6. The method of claim 4, wherein the permanent link is prior to the loading application processor by the POS manufacturer.

7. The method of claim 1, wherein both the first and second processors are on a same die.

8. The method of claim 1, wherein the token information comprises at least a primary account number of a bank card.

9. The method of claim 1, wherein the token information comprises a biometric token representing a primary account number of a bank account.

10. The method of claim 1, wherein the token to be secured is biometric information capture at the time of the transaction.

11. The method of claim 10 wherein, the biometric information is combined with one or more of: location, local and remote device and transactional data and issuer and account identity information, to reference a financial account allowing a financial transaction to be initiated or completed.

12. The method of claim 1, wherein the token information is encrypted with a unique key associated with a merchant, and wherein performing decrypting comprises determining a correct decryption key based on a merchant identification and decrypting the encrypted token data using the correct decryption key.

13. The method of claim 1, further comprising re-encrypting the decrypted token information with a unique merchant key using the second microprocessor and sending the re-encrypted token data to the first microprocessor.

14. The method of claim 1, wherein the security-related task further includes one or more tasks from the group of PIN information authentication, PIN information decryption, or PIN information encryption.

15. The method of claim 1, further comprising:
receiving a PIN information;
determining whether the PIN information is encrypted using the first microprocessor;
decrypting the PIN information using the second microprocessor;
re-encrypting the decrypted token information with the decrypted PIN information using the second microprocessor; and
sending the re-encrypted token data to the first microprocessor.

16. A secure transaction apparatus configured to process financial transactions, the secure transaction apparatus comprising:
a first processor configured to receive a token information from a token card and to determine whether the token information is encrypted;
a communication channel configured to allow the first processor to send a job request to another processor, wherein the communication channel is configured to allow a job request for decryption, encryption, authentication, and keys management functions; and
a second processor configured to decrypt an encrypted token information based on a request to decrypt the token information from the first microprocessor and to authenticate the decrypted token information using an authentication information.

17. The apparatus of claim 16, wherein both of the first and second processors are contained within the same security housing.

18. The apparatus of claim 16, wherein the second processor is a security processor based on a smart card enabled processor.

19. The apparatus of claim 16, wherein the first and second processors are permanently linked and then the linking capabilities are disabled once the processors are successfully linked preventing and further modification of the linked connection.

20. The apparatus of claim 19, wherein the permanent link is accomplished at the first power up cycle of the application processor and the security processor.

21. The apparatus of claim 19, wherein the permanent link is prior to the loading application processor by the POS manufacturer.

22. The apparatus of claim 16, wherein both the first and second processors are on a same die.

23. The apparatus of claim 16, wherein the token information comprises at least a primary account number of a bank card.

24. The apparatus of claim 16, wherein the token information comprises a biometric token representing a primary account number of a bank account

25. The apparatus of claim 16, wherein the token to be secured is biometric information captured at the time of the transaction.

26. The apparatus of claim 25 wherein, the biometric information is combined with one or more of: location, local and remote device and transactional data and issuer and account identity information, to reference a financial account allowing a financial transaction to be initiated or completed.

27. The apparatus of claim 16, wherein the token information is encrypted with a unique key associated with a merchant, and wherein performing decrypting comprises determining a correct decryption key based on a merchant identification and decrypting the encrypted token data using the correct decryption key.

28. The apparatus of claim 16, further comprising re-encrypting the decrypted token information with a unique merchant key using the second microprocessor and sending the re-encrypted token data to the first microprocessor.

29. The apparatus of claim 16, wherein the security-related task further includes one or more tasks from the group of PIN information authentication, PIN information decryption, or PIN information encryption.

30. The apparatus of claim 16, further comprising:
receiving a PIN information;
determining whether the PIN information is encrypted using the first microprocessor;
decrypting the PIN information using the second microprocessor;
re-encrypting the decrypted token information with the decrypted PIN information using the second microprocessor; and
sending the re-encrypted token data to the first microprocessor.

31. A secure transaction apparatus configured to process financial transactions, the secure transaction apparatus comprising:
a token reader configured to extract token data from a token card, the card reader having a first security module;
a user interface module having a third security module;
a communication interface coupled to the card reader, the display module, and the user interface;
wherein each of the security modules comprises:
a first microprocessor configured to perform a non-security task on a token information, wherein the non-security task includes one or more tasks from the group of encryption determination, encryption-decryption request, key management, token information delivery, or transactional data delivery; and
a second microprocessor configured to perform a security-related task on the token information based on a request from the first microprocessor, wherein the security-related task includes one or more tasks from the group of token information authentication, token information decryption, or token information encryption.

32. The secure transaction apparatus of claim 31, further comprising an encrypted inter-module communication channel for secure transfer of data, including token information between security modules.

33. The secure transaction apparatus of claim 31, further comprising:
a biometric module configured to collect biometric data from a user, the biometric module having a third security module, wherein the third security module is similar to the first security module.

34. The secure transaction apparatus of claim 31, further comprising the use of the biometric token reader the verify the identity of the POS user.

35. The secure transaction apparatus of claim 31, further comprising the use of the biometric token reader to provide POS for secure transactions without the use of magstripe data.

36. The secure transaction apparatus of claim 31, further comprising the use of the biometric token reader in conjunction with the use of magstripe data providing two factor authentication of the card holder.

37. The secure transaction apparatus of claim 31, further comprising:
a keypad module configured to collect PIN information from a user, the keypad module having a third security module, wherein the third security module is similar to the first security module.

38. A method for updating secure transaction information comprising:
receiving a token information;
performing a non-security task on the token information using a first processor, wherein the non-security task includes at least one task from the group including: encryption determination, encryption-decryption request, key management, token information delivery, and transactional data delivery;
sending a job request to a second processor through a register using the first processor; and
performing a security-related task based on the on the token information using the second processor based on the job request from the first microprocessor, wherein the security-related task includes at least one task from the group including token information authentication, token information decryption, or token information encryption, wherein both the first and second processors are within a same security housing, wherein the second processor is configured to accept the job request only if it is for one of the security-related tasks.

39. The method of claim 38, wherein both the first and second processors are on a same die.

40. The method of claim 38, wherein a secure application processor requesting the secure transaction information update is within the POS.

41. The method of claim 38, wherein a secure application processor requesting the secure transaction information update is located at a decryption appliance.

42. The method of claim 38, wherein a PKI exchange is used to initiate the secure information update.

43. The method of claim 38, wherein a secure application processor requesting a secure information update is located at a decryption appliance.

44. The method of claim 38, wherein a symmetric key is used to initiate the secure information update.

45. The method of claim 38, wherein a secure application processor requesting a secure information update is located at a decryption appliance.

46. The method of claim 18, wherein secure applications received from an external source are decrypted and processed by the security processer to update the software running in the non-security processor.

47. A method for sending compliance and status information, comprising:
performing a non-security task on a token information using a first processor, wherein the non-security task includes at least one task from the group including: encryption determination, encryption-decryption request, key management, token information delivery, or transactional data delivery;
sending a job request to the second processor through a register using the first processor; and
performing a security-related task based on the on the token information using a second processor based on the job request from the first microprocessor, wherein the security-related task includes at least one task from the group including token information authentication, token information decryption, or token information encryption, wherein both the first and second processors are within a same security housing, wherein the second processor is configured to accept the job request only if it is for one of the security-related tasks.

48. The method of claim 47, wherein both the first and second processors are on a same die.

49. The method of claim 47, wherein a secure application processor receiving the compliance and status information is within the POS.

50. The method of claim 47, wherein the secure application processor receiving the compliance and status information is located at a decryption appliance.

51. The method of using a COTS (commercial off the shlef) processor to provide the accurate analog magnetic peak location detector wherein the peak detector comprises two signal paths, both representing the analog head amplified by in fixed gain increment and in addition one signal path being delayed by a fixed amount, whereby each of the two signals representing an input to a comparator, wherein the output of the comparator changes as the delayed signal has a higher magnitude then the non-delayed signal, and further wherein the changing output of the comparator representing the position of the input waveform where the peak transition occurs.

52. The method of claim 51, wherein the output of the accurate analog magnetic peak location detector is used for the purpose of decoding the magstripe data.

53. The method of claim 51, wherein the output of the accurate analog magnetic peak location detector is used for the purpose of accurately locating the magnetic peak transitions for providing the required data for magstripe authentication system such as Warble®.

54. The method of claim 53, wherein the peak location data is for providing the required data for the Warble® card data authentication system

55. The method of claim 51, wherein the COTS (commercial off the shelf) processor is contained within the magnetic head.

56. The method of claim 51, wherein the COTS (commercial off the shelf) processor includes programmable analog and digital resources for providing the analog two signal paths.

57. The method of claim 51, wherein the COTS processor provides a programmable analog window comparator to enable setting a threshold voltage magnitude to reject false peak triggers when the input signal is close to ground between peak detections.

58. The method of claim 51, wherein the COTS processor is used in conjunction with a security processor to securely process financial transactions.

59. The method of claim 58, wherein the COTS processor and the security processor is contained within a magnetic head.

60. The method of claim 58, wherein the security processor is also available to perform transaction related secure operations normally provided by the POS HSM (Hardware Security Module).

61. A magstripe reader comprising multiple communications interfaces, one for mobile devices where a headphone jack reader is required and a second for devices requiring an USB communication channel.

62. The method of claim 61, wherein the multiple communications interfaces are retractable with their respective cavities in the plastic reader housing.

63. A method for processing customer payments through a customer's bank (issuer) in exchange for a seller's goods or services, comprising:
receiving or capturing, token information identifying the customer, the customer's bank account, the seller, and the sale transaction,
performing one or more non-security tasks on that information using a first (application) processor, wherein those tasks are drawn from the group of data transforms, encryption method determinations, encryption-decryption requests, key management, token information delivery, localized secure transport, and non-secure business logic;
sending a request to a second (security) processor to perform security-related tasks based on the token information received from the first microprocessor, wherein the security-related tasks are drawn from the group of confidentiality (encryption, decryption), user authentication, data authentication, data origin authentication, non-repudiation of origin, identity of keys and methods, and the return of the secured data to the first processor.

64. The method of claim 63, wherein the customer identity is biometric information.

65. The method of claim 63, wherein IP, MAC addresses, or phone numbers, are combined with biometric information to identify the customer.

66. The method of claim 63, wherein the customer account information is a bank issued payment card, or any customer entered or selected bank account number.

67. The method of claim 63, wherein the seller and sale transaction information include a date, the merchant identity, the transaction identity, and any other information which the issuing bank and merchant agree is relevant to identify the transaction.

68. The method of claim 63, wherein additionally the geographic location of the transaction is included in the data to be secured. The geographic location of the transaction data can be either the location of the merchant's point-of-service device, or the customer's mobile device when the latter acts as the point-of-service device.

69. The method of claim 63, wherein the first processor is on a mobile device and the second processor is on an external device accessible via USB, serial, or Bluetooth communication.

70. The method of claim 63, wherein both of the first and second processors are within a same security housing.

71. The method of claim 63 wherein both of the first and second processors are on the same die.

72. The method of claim 63 where the second security processor holds keys and certificates issued by and identifying the issuer.

73. The method of claim 63 where the second security processor holds keys and certificates issued by and identifying the merchant when the sale takes place at a merchant site being differentiated from internet and mail order type sales.
